(19) United States
(12) Patent Application Publication
(10) Pub. No.: US 2024/0398037 A1
(43) Pub. Date: Dec. 5, 2024

(54) TEMPERATURE PROFILE FOR EXTERNAL HEATING

(71) Applicant: Philip Morris Products S.A., Neuchatel (CH)

(72) Inventors: Michel BESSANT, Neuchatel (CH); Anna CANAL PONSICO, Lausanne (CH); Frédéric LAVANCHY, Chavornay (CH); Johannes Petrus Maria PIJNENBURG, Neuchatel (CH); Fabrice STEFFEN, Colombier (CH); Jun Wei YIM, Colombier (CH)

(73) Assignee: Philip Morris Products S.A., Neuchatel (CH)

(21) Appl. No.: 18/702,149

(22) PCT Filed: Oct. 28, 2022
(86) PCT No.: PCT/EP2022/080295

§ 371 Date: Apr. 17, 2024

(30) Foreign Application Priority Data
Oct. 29, 2021 (WO) PCT/CN2021/127475

(51) Int. Cl. A24F 40/57; A24F 40/20; A24F 40/46; A24F 40/485; A24F 40/53

(52) U.S. Cl. CPC A24F 40/57; A24F 40/46; A24F 40/53; A24F 40/20; A24F 40/485

(57) ABSTRACT

A method of controlling aerosol production in an aerosol-generating device is provided, the device including a heating chamber to receive an aerosol-generating article including an aerosol-forming substrate, a heater including a heating element to externally heat the substrate, and a power source to provide power to the heating element; and the method including: controlling the power provided such that in an initial period a temperature of the heating element increases from an initial to a first temperature between 230° C.-270° C., drops in a second period to a second temperature below the first, and increases in a third period to a third temperature higher than the second, and the device generating the aerosol during a usage session, dividing the session into n sequential time intervals, and limiting the power during any or each of intervals such that a threshold energy for that interval is not exceeded.

The present disclosure relates to a method of controlling aerosol production in an aerosol-generating device, an aerosol-generating device for generating an aerosol from an aerosol-forming substrate, and an aerosol-generating system comprising the aerosol-generating device.

Aerosol-generating devices configured to generate an aerosol from an aerosol-forming substrate, such as a tobacco-containing substrate, are known in the art. Many known aerosol-generating devices generate aerosol by the application of heat to the substrate by a heater assembly. The heater assembly is heated when it is supplied with power from a power supply of the aerosol-generating device. The generated aerosol can then be inhaled by a user of the device.

Typically, the power supply of the aerosol-generating device is a portable power supply, such as a rechargeable battery, such that the aerosol-generating device itself is portable and does not need to be connected to mains electricity. A disadvantage of portable power supplies, such as rechargeable batteries, is that their maximum voltage (and so maximum power output) often varies depending on the charge state of the power supply. In particular, the maximum voltage that can be supplied by the portable power supply will be highest when the power supply is fully charged and will decrease as the portable power supply is depleted. This can result in an inconsistent user experience when the power supply is fully charged compared to when the power is somewhat or entirely depleted.

The highest power demands during a usage session of the aerosol-generating device are typically in an initial, or pre-heating, phase of the puff. This is because, in the pre-heating phase, the heater assembly is required to increase temperature from an initial temperature, often close to ambient or room temperature, to an operating temperature in which significant aerosol is generated. Thus, it is the pre-heating phase of the usage session which is most affected by the variability in the voltage of the power supply. In particular, it will take longer for the heater assembly to reach operating temperature as the power supply is depleted. A depleted power supply may also result in lower quantities of aerosol being generated during a usage session.

It would be desirable to provide an aerosol-generating device in which the user experience is consistent irrespective of the charge state of the power supply. In particular, it would be desirable to provide an aerosol-generating device in which the time taken for the heater assembly to reach the operating temperature is consistent irrespective of the charge state of the power supply and in which the amount of aerosol generated during a usage session is consistent irrespective of the charge state of the power supply.

Aerosol-generating devices are often configured to control the heating of the heater assembly according to a predetermined heating routine or profile. The predetermined heating routine or profile typically comprises the above mentioned pre-heating phase in which high power is supplied to the heater assembly for a fixed period of time to ensure the heater assembly reaches the operation temperature.

It would be desirable to minimise the duration of the pre-heating phase where appropriate. This would have the benefits of reducing the power consumption during a usage session which would increase the length of time between charges of the portable power supply as well as reducing the amount of time a user has to wait from the start of a usage session before the aerosol-generating device produces significant amounts of aerosol.

Some prior art devices comprise a heater assembly in the form of a heater blade comprising a resistive heater element. These devices are configured to be used with an aerosol-generating article in shape of a rod and comprising an aerosol-forming substrate at a distal end of the rod. In use, the article is inserted into a cavity of the aerosol-generating device and the heater blade is configured to penetrate the aerosol-forming substrate. Such devices internally heat the aerosol-forming substrate. These devices have the advantage of direct contact between the substrate and the heater. However, the complexity and cost of the aerosol-generating device can be reduced, and the robustness improved, if an external heater assembly is used. In particular, providing a flexible heater assembly having heater tracks deposited on a flexible substrate wrapped around an external surface of a cavity for receiving an aerosol-forming substrate simplifies manufacture and improves the robustness of the aerosol-generating device.

Both the problems of inconsistent power and the need to reduce the length of the preheating phase are more acute for devices employing a low cost heater assembly that is external to the aerosol-forming substrate. The heater tracks of the external heater typically have a higher resistance than the heater element of the heater blade. This means a higher voltage is required for the same amount of heating which makes it even more noticeable when the battery becomes depleted. Furthermore, the pre-heating phase may be longer for external heaters given the lack of direct contact between a heater element of the external heater and the aerosol-forming substrate.

It would be desirable to provide a simple and low cost aerosol-generating device comprising an external heater assembly that does not suffer from the problems of inconsistent power and in which the duration of the pre-heating phase is minimised where appropriate.

As described above, aerosol-generating devices often implement some sort of heating routine. In order to follow the heating routine, the aerosol-generating device will typically comprise a means for measuring the temperature of the heater assembly and act accordingly in response to these temperature measurements, for example to heat to a target temperature.

In some prior art aerosol-generating devices, the resistance of a heater element of the heater assembly is highly temperature dependent and so a controller of the aerosol-generating device can determine the temperature based on the resistance of the heater element.

An alternative solution is for the aerosol-generating device to comprise a dedicated temperature sensor for measuring the temperature of the heater element. However, the temperature measured by a temperature sensor often does not accurately reflect the actual temperature of the heater element, particularly when the heater element is changing rapidly in temperature. This is because it takes time for heat from the heater element to be absorbed by the temperature sensor, even if there is direct contact between the temperature sensor and the heater element. This can result in, for example, the temperature of the heater element overshooting a target temperature and is a particular problem for low cost external heaters of the type described above because such heaters may be damaged by high temperatures associated with overshooting a target temperature.

It would be desirable to provide a low cost heater assembly in which overheating is avoided.

It is also desirable for aerosol-generating devices to be able to produce aerosol which is consistent over time. In devices in which an exhaustible substrate is heated continuously or repeatedly over time this can be difficult, as the properties of the aerosol forming substrate can change significantly with continuous or repeated heating, both in relation to the amount and distribution of aerosol-forming constituents remaining in the substrate and in relation to substrate temperature. In particular, a user of a continuous or repeated heating device can experience a fading of flavour, taste, and feel of the aerosol as the substrate is depleted of the aerosol former that coveys nicotine and, in certain cases, flavouring. Thus, a consistent aerosol delivery is provided over time such that the first delivered aerosol is substantially comparable to a final delivered aerosol during operation

In a first aspect there is provided a method of controlling aerosol production in an aerosol-generating device. The device comprises a heating chamber configured to at least partially receive an aerosol-generating article comprising an aerosol-forming substrate; a heater comprising at least one heating element configured to externally heat the aerosol-forming substrate; and a power source for providing power to the heating element. The method comprises the steps of controlling the power provided to the heating element such that in an initial period power is provided such that the temperature of the heating element increases from an initial temperature to a first temperature. In a second period power is provided such that the temperature of the heating element drops to a second temperature below the first temperature. In a third period power is provided such that the temperature of the heating element increases to a third temperature higher than the second temperature. Preferably the first temperature is a temperature of between 230° C. and 270° C. It is noted that the unit of temperature “° C.” is the same as the unit degrees Centigrade or degrees Celsius. Thus, the first temperature may be alternately stated as being between 230 degrees Celsius and 270 degrees Celsius.

The aerosol-generating device is preferably configured for continuous or repeated heating of an aerosol-forming substrate for an extended period of time. This contrasts with devices in which heating is only applied at moments when a user takes a puff. For example, the device may be configured for continuous heating over the duration of a usage session, the usage session having a duration of at least 1 minute, preferably at least 2 minutes, for example greater than three minutes, or greater than 4 minutes. Preferably a usage session has a duration of between 3 minutes and 6 minutes, for example about 4 and a half minutes. The device may be configured for continuous heating over a series of several user puffs. For example, the heater may be controlled to heat an aerosol-forming substrate over a sequence of at least 3 user puffs, for example at least 4 user puffs, or at least 6 user puffs. A usage session may have a duration at least in part controlled by user puffs. A usage session may extend for a duration of between 6 and 16 user puffs, for example between 8 and 14 user puffs, for example between 10 and 12 user puffs.

As used herein, continuous or repeated heating means that the substrate or a portion of the substrate is heated to generate aerosol over a sustained period, typically more than 5 seconds and may extend to more than 30 seconds, for example over the duration of a usage session. In the context of an aerosol-generating device, or other device on which a user puffs to withdraw aerosol from the device, this means heating the substrate over a period containing a plurality of user puffs, so that aerosol is continuously generated, independent of whether a user is puffing on the device or not. In this context depletion of the substrate may become a significant issue. This is in contrast to flash heating, in which a separate substrate or portion of the substrate is heated for each user puff, so that no portion of the substrate is heated for more than one puff where a puff duration is approximately 2-3 seconds in length.

As used herein, the terms “puff” and “inhalation” are used interchangeably and are intended to mean the action of a user drawing an aerosol into their body through their mouth or nose. Inhalation includes the situation where an aerosol is drawn into the user's lungs, and also the situation where an aerosol is only drawn into the user's mouth or nasal cavity before being expelled from the user's body.

The first, second, and third temperatures are preferably chosen such that aerosol is generated continuously during the first, second and third periods. The method involves heating to a first temperature of between 230° C. and 270° C. before allowing the temperature to drop to a second temperature lower than the first temperature. If the heating element was a heater for insertion into an aerosol-generating device, it would not be expected that such a low temperature could produce a consistent aerosol over a series of user puffs. However, the use of the low first temperature followed by an even lower second temperature, in combination with a heating element configured for external heating of the aerosol-generating device, appears to allow for consistent and complete aerosol-generation from an aerosol-forming substrate. This temperature range appears to provide optimum conditions for aerosol-generation from an aerosol-generating article comprising an aerosol-forming substrate when heated in a heating chamber of an aerosol-generating device that utilises an external heater, that is a heater that supplies heats to an external portion of the aerosol-generating article.

As used herein, an ‘aerosol-generating device’ relates to a device that interacts with an aerosol-forming substrate to generate an aerosol. The aerosol-forming substrate may be part of an aerosol-generating article, for example part of a smoking article. An aerosol-generating device may be a smoking device that interacts with an aerosol-forming substrate of an aerosol-generating article to generate an aerosol that is directly inhalable into a user's lungs thorough the user's mouth. An aerosol-generating device may be a holder.

As used herein, the term ‘aerosol-forming substrate’ relates to a substrate capable of releasing volatile compounds that can form an aerosol. Such volatile compounds may be released by heating the aerosol-forming substrate. An aerosol-forming substrate may conveniently be part of an aerosol-generating article or smoking article.

As used herein, the term ‘aerosol-generating article’ refers to an article comprising an aerosol-forming substrate that is capable of releasing volatile compounds that can form an aerosol. For example, an aerosol-generating article may be an article that generates an aerosol that is directly inhalable into a user's lungs through the user's mouth. An aerosol-generating article may be disposable.

The first temperature may be a temperature of between 245° C. and 265° C., for example the first temperature may be a temperature of between 250° C. and 260° C., for example about 255° C. The first temperature may be towards the lower end of the range between 230° C. and 270° C., for example the first temperature may be temperature of between 230° C. and 250° C., for example the first temperature may be a temperature of between 235° C. and 245° C., for example about 240° C.

The second temperature may be a temperature of between 140° C. and 220° C. For example, the second temperature may be a temperature of between 180° C. and 210° C. The second temperature may be a temperature of between 190° C. and 200° C., for example about 195° C. or about 200° C.

The third temperature may be a temperature of between 230° C. and 270° C. The third temperature may be a temperature of between 245° C. and 265° C. The third temperature may be a temperature of between 250° C. and 260° C., for example about 250° C. or about 255° C.

In the first period the temperature of the heating element is raised to the first temperature at which aerosol is generated from the aerosol-forming substrate. It is desirable to generate aerosol with the desired constituents as soon as possible after activation of the device. For a satisfactory consumer experience, the “time to first puff” is considered to be critical. Consumers do not want to have to wait for a significant period following activation of the device before having a first puff. For this reason, in the first period, power may be supplied to the heating element to raise it to the first temperature as quickly as possible. The delivery of aerosol may be diminished by condensation within the device during the initial period of device operation. Preferably, the first period has a duration of between 20 seconds and 40 seconds, for example between 25 seconds and 35 seconds, for example about 30 seconds.

When the first period is ended, the second period begins and the power to the heating element is controlled so as to reduce the temperature of the heating element to a second temperature that is lower than the first temperature. This reduction in temperature of the heating element is desirable because as the device and substrate warms, condensation is reduced and delivery of aerosol increased for a given heating element temperature. In addition, reducing the heating element temperature reduces the amount of energy consumed by the aerosol-generating device. Moreover, varying the temperature of the heating element during operation of the device allows for a time-modulated thermal gradient to be introduced into the substrate. The second period may have a duration of between 40 seconds and 100 seconds, for example between 50 seconds and 90 seconds, for example between 60 seconds and 80 seconds, for example about 70 seconds.

In the third period the temperature of the heating element is increased. As the substrate becomes more and more depleted during the third period it may be desirable to increase the temperature continually. The increase in temperature of the heating element during the third period compensates for the reduction in aerosol delivery due to substrate depletion and reduced thermodiffusion. However, the increase in the temperature of the heating element during the third period may have any temporal profile desired and may depend on the device and substrate geometry, substrate composition and on the duration of the first and second periods. It is preferable for the temperature of the heating element to remain within the allowable range throughout the third period. In one embodiment, the step of controlling the power to the heating element is performed so as to continuously increase the temperature of the heating element during the third period. The third period may have a duration of between 40 seconds and 100 seconds, for example between 50 seconds and 90 seconds, for example between 60 seconds and 80 seconds, for example about 70 seconds.

The aerosol-generating device may be configured to generate the aerosol during a usage session, the usage session having a usage session start and a usage session end. Preferably, the temperature of the heating element is at the initial temperature at the usage session start and in which the end of the third period is the usage session end.

The step of controlling the power provided to the heating element may be performed so as to maintain the temperature of the heating element within a desired temperature range in the second period and in the third period of the usage session. The desired temperature range may have a lower bound of between 140° C. and 220° C. and an upper bound of between 230° C. and 270° C.

The step of controlling the power to the heating element may comprise measuring a temperature of the heating element or a temperature proximate to the heating element to provide a measured temperature, performing a comparison of the measured temperature to a target temperature, and adjusting the power provided to the heating element based a result of the comparison. The target temperature preferably changes with time following activation of the device to provide the first, second and third periods. For example, during a first period the target temperature may be a first target temperature, during a second period the target temperature may be a second target temperature and during a third period the target temperature may be a third target temperature, wherein the third target temperature progressively increases with time. It should be clear that the target temperature may be chosen to have any desired temporal profile within the constraints of the first, second and third phases of operation.

The first period may end when the heating element reaches the first temperature. A duration of the second period may be determined based on a total amount of power provided to heating element during the second period.

The method may comprise a step of detecting user puffs on the aerosol-generating device. The first, second or third period may end following detection of a predetermined number of user puffs.

The method may comprise the step of identifying a characteristic of the aerosol-forming substrate. The step of controlling the power may be dependent on the identified characteristic.

The heating element is for external heating of the aerosol-forming substrate. The heating element may be arranged to substantially surround an aerosol-generating article received in the heating chamber. The heating element may be arranged around the heating chamber.

The aerosol-generating device may be configured to generate the aerosol during a usage session. The usage session may comprise a plurality of sequential phases between a usage session start and the usage session end, wherein each of the phases of the plurality of sequential phases begins at a phase start and ends at a phase end.

Preferably, progress of the usage session through the plurality of sequential phases is controlled by a controller. Progress of the usage session through the plurality of sequential phases may be controlled by the controller determining at least one of: the length of time since the phase start is equal to or exceeds a predetermined duration; and the temperature is equal to or exceeds a target temperature. During each phase, the controller may be configured to control the supply of power to the heating element such that the heating element is heated in reference to a target temperature.

The plurality of sequential phases may comprise a first phase having a first phase target temperature. A first phase end may be a first predetermined time after a first phase start.

The plurality of sequential phases may comprise a second phase having a second phase target temperature. A second phase end may be the earlier of the controller determining that the temperature of the heater element is greater than or equal to the second target temperature or the controller determining that the time elapsed since the second phase start is equal to or exceeds a second predetermined time.

The plurality of sequential phases may comprise a third phase having a third phase target temperature. The controller may be configured to repeatedly determine a temperature of the heater element to determine a rate of change of the temperature of the heater element.

Each of the first period, second period and third period may comprise a plurality of sequential phases, for example between 1 and 4 sequential phases.

The first period may comprise a first phase having a first target temperature and a second phase having a second target temperature greater than the first target temperature. The second target temperature may be the same temperature as the first temperature. The first target temperature may be between 200° C. and 220° C., for example about 210° C.

The first phase may end between 5 and 10 seconds after the usage session start, for example about 8 seconds after the usage session start. The second phase may end between 15 and 25 seconds after the usage session start, for example about 20 seconds after the usage session start.

The first period may further comprise a third phase having a third target temperature. The third target temperature may be the same temperature as the first temperature. The third phase may end between 25 and 35 seconds after the usage session start, for example about 30 seconds after the usage session start.

The usage session may further comprise a fourth phase having a fourth target temperature. The fourth target temperature may be the same temperature as the second temperature, for example the fourth phase may end between 60 and 90 seconds after the usage session start, for example about 65 seconds after the usage session start.

The usage session may further comprise a fifth phase having a fifth target temperature. The fifth target temperature may be the same temperature as the second temperature. The fifth phase may end between 90 and 110 seconds after the usage session start, for example about 105 seconds after the usage session start.

The second period may comprise the fourth phase and the fifth phase.

The usage session may further comprise a sixth phase having a sixth target temperature. The sixth target temperature may be higher than the second temperature. The sixth target temperature may be between 215° C. and 220° C. The sixth phase may end between 150 and 180 seconds after the usage session start, for example about 165 seconds after the usage session start.

The usage session may further comprise a seventh phase having a seventh target temperature. The seventh target temperature may be higher than the second temperature, for example the seventh target temperature may be between 220° C. and 230° C. The seventh phase may end between 180 and 220 seconds after the usage session start, for example about 200 seconds after the usage session start.

The usage session may further comprise an eighth phase having an eighth target temperature. The eighth target temperature may be higher than the second temperature, for example the eighth target temperature may be between 245° C. and 255° C. The eighth phase may end between 230 and 260 seconds after the usage session start, for example about 250 seconds after the usage session start.

The usage session may further comprise a ninth phase having an ninth target temperature. The ninth target temperature may be the same as the third temperature, for example the ninth phase may end between 220 and 280 seconds after the usage session start, for example about 265 seconds after the usage session start.

The third period may comprise the sixth, seventh, eighth, and ninth phases.

In a further aspect, there is provided an electrically operated aerosol-generating device. The device comprises a heating chamber configured to at least partially receive an aerosol-generating article comprising an aerosol-forming substrate; a heater comprising at least one heating element configured to externally heat the aerosol-forming substrate; a power source for providing power to the heating element; and electric circuitry for controlling supply of power from the power supply to the at least one heating element. The electric circuitry is arranged to control the power provided to the heating element such that in an initial period power is provided such that the temperature of the heating element increases from an initial temperature to a first temperature, in a second period power is provided such that the temperature of the heating element drops to a second temperature below the first temperature, and in a third period power is provided such that the temperature of the heating element increases to a third temperature higher than the second temperature. The first temperature is preferably a temperature of between 230° C. and 270° C.

The electric circuitry may be configured such that at least one of the first period, second period and third period has a fixed duration.

The device may further comprise means for detecting user puffs on the aerosol-generating device, wherein the electric circuitry may be configured such that at least one of the first, second or third period is ended following detection of a predetermined number of user puffs.

An electrically operated aerosol-generating device may be provided in which the device is configured to operate any method disclosed herein.

In a further aspect, there is provided an aerosol-generating system comprising an aerosol-generating device as disclosed herein and an aerosol-generating article configured to be received in the heating chamber of the aerosol-generating device.

The aerosol-generating article comprises an aerosol-forming substrate, preferably an aerosol-generating substrate having a length of at least 5 millimetres, preferably in which the aerosol-generating substrate has a length of no more than 80 millimetres. The aerosol-generating substrate may have a density of no more than 0.5 grams per cubic centimetre.

The aerosol-generating article may have a length of at least 35 millimetres. The aerosol-generating article may have a length of no more than 100 millimetres.

Further suitable aerosol-generating articles are disclosed below.

In a further aspect there is provided an aerosol-generating device for generating an aerosol from an aerosol-forming substrate. The aerosol-generating device may be configured to generate the aerosol during a usage session. The aerosol-generating device may comprise a timer. The aerosol-generating device may comprise a heater assembly. The heater assembly may comprise a heater element for heating the aerosol-forming substrate. The aerosol-generating device may comprise a power supply. The power supply may be configured to supply power to the heater assembly. The aerosol-generating device may comprise a controller.

At least a portion of the usage session may be divided into n sequential time intervals.

The controller may be configured to limit the power supplied to the heater element during any or each of the n sequential time intervals.

The power may be limited to a threshold average power. For example, an average power supplied during any or each of the sequential intervals may not exceed a threshold for that time interval. That is, any or each of the n sequential time intervals may have an average power threshold, and an average of the power supplied during a time interval may not exceed the respective threshold average power. The threshold average power may be different for each time interval. Preferably, the threshold average power may be the same for each time interval.

As an example, during a portion of the or each time interval an instantaneous power supplied to the heater assembly may be higher than the threshold average power for that time interval. To account for this, the instantaneous power supplied to the heater assembly for another portion of that time interval may be lower than the threshold average power for that time interval. In this way, the average power supplied during any or each time interval may be limited so as to not exceed the respective threshold average power. Preferably, the instantaneous power supplied to the heater assembly during a time interval may either be higher than the threshold average power for that time interval or zero.

As used herein, “instantaneous power” means the power supplied to the heater assembly as measured in a given moment. The instantaneous power may be higher than the threshold average power. Additionally, or alternatively, the instantaneous power may be lower than the threshold average power. Preferably, when the instantaneous power is lower than the threshold average power, the instantaneous power may be zero.

In a specific example, the threshold average power supplied to the heater assembly for a time interval may be 10.8 Watts. For a first portion of the time interval (for example, a first half of the time interval), an instantaneous power of 21.6 Watts may be supplied, which is higher than the threshold average power. For a second portion of the time interval (for example, a second half of the time interval), the instantaneous power supplied to the heater assembly may be zero. In this way, the average power supplied to the heater assembly during the time interval may be 10.8 Watts. In other words, the power, and particularly the average power, supplied during the time interval may be limited to the threshold average power. In another example, the threshold average power for a time interval may be 10.8 Watts. An instantaneous power of 14.4 Watts may be supplied to the heater assembly for three quarters of the time interval. To ensure that the average power during that time interval does not exceed 10.8 Watts, the power supplied during the remaining quarter of the time interval may be zero.

The controller may be configured to limit the power supplied to the heater assembly during any or each of the n sequential time intervals such that a threshold energy for that time interval is not exceeded. Preferably, a threshold energy may not be exceeded for each of the n sequential time intervals.

The threshold energy may correspond to a maximum amount of energy supplied to the heater assembly during the respective time interval. Because of the relationship between power and energy, limiting the power supplied during any or each of the n sequential time intervals to a threshold average power may be another way of saying that the power supplied during any or each of the n sequential time intervals is limited such that the threshold energy for that interval is not exceeded.

The threshold energy may be equal to the power threshold multiplied by the length of time interval. This may be because energy is equal to power multiplied by time. The threshold energy may be different for different time intervals. For example, the threshold energy may be different for different time intervals if the n sequential time intervals vary in length. Alternatively or additionally, the threshold energy may be different for different time intervals if the threshold average power is different for different time intervals.

Limiting the power or energy supplied to the heater assembly during any or each of the n sequential time intervals may advantageously reduce or minimise any inconsistencies in the amount of power or energy that is supplied by the power supply during the n sequential time intervals in different usage sessions.

As used herein, a “usage session” refers to a period of use of the device beginning with activation of the device by the user. The usage session may comprise a pre-heating phase in which the aerosol-generating device is configured to supply power to the heater assembly to heat the aerosol-forming substrate to generate aerosol. The usage session may comprise a main phase during which the user may inhale the generated aerosol. The main phase may be long enough for a plurality of puffs. The main phase may be long enough for three, four, five or six puffs. The main phase may be long enough for more than six puffs. At the end of the usage phase, the aerosol-generating device may be configured to stop supplying power to heater assembly. The aerosol-forming substrate may be removed from the aerosol-generating device at the end of the usage session. The aerosol-forming substrate may be replaced in a later usage session. The duration of the usage session, between a usage session start and a usage session end may be at least one, two, three, four, five or six minutes. Preferably, the usage session may have a duration of about four and a half minutes.

Inconsistencies in the energy or power supplied by the power supply in different usage sessions may be a particular problem when the power supply is a portable power supply for storing energy. A portable power supply may be a battery, for example a rechargeable battery.

Each subsequent usage session may cause such a portable power supply to loose energy and so become more depleted. As the portable power supply is depleted, the maximum voltage it is able to supply may decrease and so the maximum instantaneous power that can be supplied by the portable power supply may decrease. Because energy is related to power, the maximum energy the power supply can supply to the heater assembly in a given period may also decrease as the maximum instantaneous power decreases. Therefore, without any kind of limitation on the power or energy supplied, the maximum instantaneous power supplied during early usage sessions when the portable power supply is fully charged may be higher compared to later usages sessions when the portable power supply is depleted.

Limiting the power that is supplied during any or each of the n sequential time intervals may advantageously mean that a consistent power can be supplied during any or each time interval regardless of the charge state of the power supply.

Energy is related to power in that energy is equal to the power supplied multiplied by time. So, limiting the power supplied during a time interval also limits the energy supplied to the heater assembly during that time interval. Limiting power such that a threshold energy for the n sequential time intervals is not exceeded may similarly advantageously mean that a consistent amount of energy is supplied during any or each of the n sequential intervals regardless of the charge state of the power supply. This may be because the threshold energy for the nth sequential interval corresponds to a maximum amount of energy that the power supply can supply to the heater assembly during any or each of the n sequential time intervals in most charge states of the power supply. Given the relationship between power and energy, the threshold energy may depend on the length of the nth sequential time interval.

The threshold energy may relate to the amount of energy supplied to the heater assembly during any or each of the n sequential time intervals, preferably each of the n sequential time intervals. The threshold energy may be less than 1 Joule supplied to the heater assembly during any or each of the n sequential time intervals. The threshold energy may preferably be less than 0.8 Joules supplied to the heater assembly during any or each of the n sequential time intervals. The threshold energy may, even more preferably, be less than 0.6 Joules supplied to the heater assembly during any or each of the n sequential time intervals. These amounts for the threshold energy represent amounts which the portable power supply may advantageously be able to supply even after a plurality of usage sessions.

The threshold energy may be more than 0.4 Joules. Preferably, the threshold energy may be more than 0.45 Joules. Even more preferably, the threshold energy may be more than 0.5 Joules. This is because, although it is advantageous to limit the amount of energy supplied during any or each of the n time intervals, it is important not to limit the energy too much otherwise there would not enough energy available for adequately heating the heater assembly to a temperature in which substantial aerosol is generated.

The threshold energy may be less than the maximum energy that can be delivered by the power supply in any or each of the n sequential time interval when the power supply is fully charged. The threshold energy may advantageously be chosen as an amount of energy that the portable power supply can supply in any or each of the n sequential time intervals even after at least 5, at least 10, at least 15 or even at least 20 usages sessions. For example, the threshold energy may be at least 10% lower than the maximum energy. Preferably, the threshold energy may be at least 15% lower than the maximum energy. Even more preferably, the threshold energy may be at least 20% lower than the maximum energy.

Of course, the length of the time intervals may also be important to give context to the above energy values supplied to the heater assembly. The above described energy values are particularly preferable and advantageous when any or each of the n sequential time intervals is equal 10 seconds or less, preferably 1 second or less, preferably 500 milliseconds or less, even more preferably less than 100 or less, even more preferably 75 milliseconds or less, most preferably about 50 milliseconds.

Given the relationship between power and energy, limiting the power supplied to the heater assembly during any or each of the n sequential time intervals such that a threshold energy from the n sequential time intervals is not exceeded may alternatively or additionally be described as limiting power such that the power supplied throughout any or each of the n sequential time intervals does not exceed a threshold average power.

The threshold power may be less than a maximum power that can be delivered by the power supply. The threshold average power may be less than a maximum power than can be delivered during any or each of the n sequential time intervals when the power supply is fully charged. The threshold average power may advantageously be chosen as an amount of power that the portable power supply can supply in any or each of the n sequential time intervals even after at least 5, at least 10, at least 15 or even at least 20 usages sessions. For example, the threshold average power may be at least 10% lower than the maximum power. Preferably, the threshold average power may be at least 15% lower than the maximum power. Even more preferably, the threshold average power may be at least 20% lower than the maximum power.

The threshold average power may be less than 13 Watts, preferably less than 12 Watts, even more preferably less than 11 Watts. The threshold average power may be greater than 8 Watts, preferably greater than 9 Watts, even more preferably greater than 10 Watts.

The controller limiting power or energy supplied to the heater assembly during any or each of the n sequential time intervals may comprise the controller being configured to monitor a cumulative amount of energy supplied to the heater assembly from the start of the nth time interval. The controller may be further configured to limit the supply of power or energy to the heater assembly until the end of the nth sequential time interval if the cumulative amount of energy supplied from the start of the nth time interval exceeds the threshold energy. Limiting the supply of power energy to the heater assembly may consist of stopping the supply of power or energy to the heater assembly.

Thus, for any or each of the n sequential time intervals, the amount of energy supplied advantageously may not exceed the threshold energy because, if the threshold energy is reached, the supply of energy or power may be stopped until the next time interval. When the power supply is fully charged, the power may be stopped earlier in the nth sequential time interval than when the power supply is depleted. The more the power supply is depleted, the later the power may be stopped during any or each of the n sequential time intervals.

Similarly, the power supplied during any or each of the n sequential time intervals, and particularly the average power, may not exceed the threshold average power. This is because, while the instantaneous power may exceed the threshold average power for a portion of the time interval, this may then accounted for by limiting or stopping power for another portion of the time interval.

The effect of stopping power may be that power is supplied to the heater assembly in pulses. The width and height of the pulses may depend on the charge state of the power supply. The width of the pulse may relate to time. The height of the pulse may relate to power. The pulse width may increase as the power supply is depleted. The pulse height may decrease as the power supply is depleted.

n sequential pulses may be supplied to the heater assembly while the controller is configured to limit power or energy. Provided n is sufficiently high and the duration of any or each of the n sequential time intervals is sufficiently low, the pulses may advantageously appear to give rise to a continuous supply of limited power.

The cumulative amount of energy supplied form the start of the nth time interval may not exceed the threshold energy in some cases. There may be reasons beyond the above described limitation of power or energy that the controller is configured not to supply power to the heater assembly for at least some of the nth time interval. For example, as will be described below, the controller may also be configured to perform thermostatic control of the heater assembly. This may comprise stopping power from being supplied to the heater assembly when the heater assembly exceeds a target temperature. Thus, for any of the n subsequent time intervals that at least partially overlap with the thermostatic control, the cumulative amount of energy may not reach the threshold energy. If the cumulative energy does not reach the threshold energy during one of the n sequential time intervals, the controller may still progress on to the n+1 interval.

Similarly, the power supplied to the heater assembly during any or each of the n sequential time interval may be less than the threshold average power.

The controller being configured to monitor the cumulative amount of energy may comprise the controller being configured to measure the instantaneous power supplied to the heater assembly from the power supply repeatedly during any or each of the n sequential time intervals.

Measuring the instantaneous power may comprise the controller being configured to determine the voltage and the current being supplied to the heater assembly and multiplying the determine voltage by the determined current. As such, the aerosol-generating device may further comprise a voltmeter and an ampere meter referred to herein as an ammeter. The controller may be configured to determine the voltage based on signals from the voltmeter and determine the current based on signals from the ammeter.

For each measurement of instantaneous power, the controller may be configured to determine the energy supplied to the heater assembly since the previous measurement of instantaneous of power by multiplying the measured instantaneous power by the time elapsed since the previous measurement of instantaneous power. This assumes that the instantaneous power measurement may be extrapolated between measurements. The instantaneous power measurements may be made sufficiently frequently that this assumption hold.

The controller may comprise a memory for storing a value representing the cumulative amount of energy. For each measurement of instantaneous power, the controller may be configured to add the determined energy to the value representing the cumulative amount of energy. Thus, the value representing the cumulative amount of energy may be advantageously be continually updated as energy is supplied to the heater assembly. The value representing the cumulative amount of energy may advantageously provide a running total of energy which can be compared to the threshold energy.

The controller may be configured to measure the instantaneous power supplied to the heater assembly at least 100 times a second. Preferably, the controller may be configured to measure the instantaneous power supplied to the heater assembly at least 500 times a second.

The controller may be configured to measure the instantaneous power supplied to the heater assembly less than 10,000 times a second. Even more preferably, the controller may be configured to measure the instantaneous power supplied to the heater assembly less than 5,000 times a second.

As explained above, it may be advantageous to measure the instantaneous power frequently, for example 500 times a second, so that the assumption that the instantaneous power can be extrapolated between measurements holds. However, taking measurements too frequently, for example 10,000 times a second, is computationally expensive and may introduce other errors. Most preferably, the controller may be configured to measure the instantaneous power supplied to the heater assembly about 1000 times a second.

The controller may be configured to reset the cumulative amount energy at the end of the n sequential time intervals. In particular, the controller may be configured to set value representing the cumulative amount of energy to zero at the end of any or each of the n sequential time intervals.

Each of the n sequential time intervals may be of equal length. This is advantageously the most straightforward arrangement computationally.

The duration of each of the n sequential time intervals may be 10 seconds or less, preferably 1 second or less, preferably 500 milliseconds or less, even more preferably less than 100 or less, even more preferably 75 milliseconds or less. Most preferably, the duration of each of the n sequential time intervals may be about 50 milliseconds. n may be greater than 10. Preferably, n may be greater than 50. Preferably, n may be greater than 100. More preferably, n may be greater than 1000. Even more preferably, n may be greater than 5000. These durations are sufficiently low and n is sufficiently high that the pulsed power may appear continuous, as described above. Of course, the value of n may primarily be determined by the length of the portion of the usage session in which the power or energy limitation is applied and on the length of each of the sequential time intervals.

The portion of the usage session that is divided into n sequential time intervals may be at least 5 seconds of the usage session, preferably at least 10 seconds of the usage session, even more preferably at least 15 seconds of the usage session. In other words, the controller may advantageously be configured to limit the supply of power or energy to the heater assembly for at least 5, 10 or 15 seconds.

The portion of the usage session that is divided into n sequential time intervals may be at least a pre-heating portion of the usage session. In other words, the controller may advantageously be configured to limit the power or energy supplied to the heater assembly during a pre-heating portion of the usage session. The pre-heating phase may correspond to an initial phase of the usage session. In the pre-heating phase, the temperature of heating element may be increased from ambient or room temperature to a much higher temperature in which substantial aerosol is generated. So, this may be the period of the usage session that has the highest power requirements and which may be most affected by a depleted power supply. Therefore, limiting the power or energy supplied to the heater assembly in the pre-heating may be particularly preferable.

The portion of the usage session that is divided into n sequential time intervals may start at the usage session start.

The controller may also be configured to perform the power or energy limitation after the pre-heating phase. Substantially the entire usage session may be divided into n sequential time intervals.

The resistance of the heater element may be at least 0.9 ohm.

The aerosol-generating device may comprise a temperature sensor configured to measure the temperature of the heater element. The controller may use measurements of temperature to make decisions about the control of the power supply. The provision of separate temperature sensor may provide a simple and low cost means for determining the temperature of the heater element. For example, the provision of a separate temperature sensor removes the need to provide a heater element having a resistance that is highly temperature dependent. The temperature sensor may be a Pt1000 temperature sensor.

During at least a portion of the usage session, the controller may be configured to control the supply of power to the heater assembly such that the heater element is heated with reference to one or more target temperatures. The controller may be configured to control the supply of power to the heater assembly such that the heater element is heated with reference to one or more target temperatures for the entire usage session.

The one or more target temperatures may be chosen as temperatures which result in the aerosol-forming substrate being heated in a way so as to generate significant aerosol. The one or more target temperatures may be chosen as suitable for the particular type of aerosol-forming substrate. The one or more target temperatures may advantageously be chosen to ensure a consistent amount of aerosol is generated throughout a main phase of the usage session. For example, the target temperature may increase throughout the usage session to account for depletion of the aerosol-forming substrate. This may mean that each time a user puffs on the aerosol-generating device, they may inhale a consistent amount of aerosol.

Controlling the supply of power to the heater assembly such that the heater element is heated with reference to one or more target temperatures may comprise the controller being configured to perform thermostatic control. In particular, the controller may be configured to perform thermostatic control with reference to the one or more target temperatures. When there is more than one target temperature, different target temperatures may be used at different times. For example, initially, the thermostatic control may be carried out with reference to a first target temperature. Later, the thermostatic control may be carried out with reference to a second target temperature.

The thermostatic control may comprise the controller repeatedly determining the temperature of the heater element and comparing the temperature to the respective target temperature.

The controller may be configured to limit or stop the supply of power to the heater assembly while the determined temperature of the heater element exceeds the respective target temperature. The heater element may then cool down while the supply of power is limited or stopped such that the temperature heater element approaches the respective target temperature.

The controller may be configured to supply power to the heater assembly while the determined temperature of the heater element is less than the respective target temperature. The heater element may then heat up while power is supplied such that the temperature heater element approaches the respective target temperature.

The controller may be configured to carry out thermostatic control during the portion of the usage session that is divided into n sequential time intervals. The controller may be configured to determine the temperature of the heater tracks and compare the temperature to the respective target temperature multiple times during at least some of the n sequential time intervals. During any portion of the usage session where the thermostatic control overlaps with the portion that is divided into n sequential time intervals, the controller may be configured to carry out both thermostatic control and the power or energy limitation described above. If the power or energy limitation is implemented by monitoring the cumulative amount of energy, as described above, then the cumulative energy may only reach the threshold energy during any or each of the n sequential time intervals for time intervals in which the thermostatic control requires that power is supplied to the heater assembly.

The controller may be configured to determine the temperature of the heater element and compare the temperature to the respective target temperature often enough to reduce any oscillation effects that might otherwise be caused be frequently turning the power supply off and on again. In particular, this should be often enough that the temperature of the heater assembly does not oscillate above and below the respective target temperature by more than 5 or 6 degrees Celsius, preferably less than two degrees Celsius. Furthermore, frequent determination and comparison of the temperature of the heater element may advantageously ensure that the heater element does not overshoot the respective target temperature. The controller may be configured to determine the temperature of the heater element and compare the temperature to the respective target temperature at least 100 times a second, preferably at least 500 times a second, even more preferably about 1000 times a second.

The controller may be configured to determine the temperature of the heater element and compare the temperature to the respective target temperature less than 10,000 times a second, preferably less than 5000 times a second.

The usage session may comprise a plurality of sequential phases between a usage session start and a usage session stop. Each of the phases of the plurality of sequential phases may begin at a phase start and end at a phase end. The progress of the usage session through the plurality of sequential phases may be controlled by the controller. Preferably, the progress of the usage session through the plurality of sequential phases may be controlled by the controller determining at least one of: the length of time since the phase start being equal to or exceeding a predetermined duration; and the temperature being equal to or exceeding a target temperature.

During each phase, the controller may be configured to control the supply of power to the heater element such that the heater element is heated in reference to a target temperature. The target temperature of each phase may be referred to as the phase target temperature. The phase target temperature of a particular phase may have the same value or a different value compared to phase target temperature of a subsequent or previous phase.

The plurality of sequential phases may comprise at least one of:
a first phase having a first phase target temperature and in which the first phase end is a first predetermined time after the first phase start;
a second phase having a second phase target temperature and in which the second phase end is the earlier of the controller determining that the temperature of the heater element is greater than or equal to the second target temperature or the controller determining that the time elapsed since the second phase start is equal to or exceeds a second predetermined time; and
a third phase having a third phase target temperature and in which the controller is configured to repeatedly measure a temperature of the heater element to determine a rate of change of the temperature of the heater element.

The plurality of sequential phases may comprise any combination of the first, second and third phases and in any order. For example, it may not be necessary for the first phase to come first chronologically. The plurality of phases may comprise the first and the second phase and the first phase may start before or after the second phase start.

The plurality of sequential phases may comprise further phases in addition to at least one of the first to third phases. Preferably, a usage session comprising any of the first, second and third phases comprises those phases towards the start of usage session. An initial portion of the usage session comprising any of the first, second and third phases may be referred to as pre-heating phase. In the pre-heating phase, the aerosol-generating device may be configured to rapidly heat the heater tracks towards an operational temperature in which substantial aerosol is generated from the aerosol-forming substrate.

The plurality of sequential phases may comprise the first phase. The first phase start may correspond to the usage session start.

Because the first phase has a first phase end that is a first predetermined time after the first phase start, the first phase may have a fixed length. So, the controller may be configured to progress through the first phase based on time rather than temperature. This may be particularly preferable when the first phase is part of a pre-heating phase because, advantageously, a minimum amount of energy will be delivered to the heater element during that period.

The plurality of sequential phases may comprise the second phase.

Because the second phase end is the earlier of the controller determining that the temperature of the heater element is greater than or equal to the second phase target temperature; or the controller determining that the time elapsed since the second phase start is equal to or exceeds a second predetermined time, the second phase may have a dynamic length up to a maximum length. This may mean that the length of the second phase can change depending on how quickly the heater element reaches the second phase target temperature. This may be particularly advantageous when the second phase is part of a pre-heating phase.

As described above, during the pre-heating phase, the temperature of the heater element may be increased from an initial temperature at the start of the usage session to an operational temperature in which substantial aerosol is generated from the aerosol-forming substrate. The initial temperature of the heater element may vary. The initial temperature may be equal to ambient or room temperature. If, however, the current usage session is only a short time after a previous usage session, the initial temperature of heater element may be significantly higher than ambient or room temperature. This is because the heater element may store residual heat from the previous usage session. By providing a dynamic second phase as part of a pre-heating phase, differences in the initial temperature may advantageously be accounted for. As the initial temperature increases, the heater element may reach the operational temperature, and the second phase target temperature, more quickly during the pre-heating phase. Because the second phase is dynamic, the second phase will end when the second phase target temperature is reached rather continuing for a fixed period of time. This advantageously reduces the overall length of the pre-heating phase. This may advantageously mean that the aerosol-generating device is more quickly ready for inhalation of aerosol by a user during a usage session as well as reducing power consumption which is important when the power supply is a portable power supply such as a rechargeable battery.

The plurality of sequential phases may comprise the first phase and the second phase. The combination of the first and second phase may be particularly preferable, especially if the first and second phases are part of a pre-heating phase. As described above, the dynamic second phase may reduce the overall length of the pre-heating phase. However, it may be advantageous to include the further fixed length first phase to ensure that a minimum amount of energy is transferred to the heater element even if the initial temperature of the heater element is high. This may be because, in order for aerosol to be released from the aerosol-forming substrate, the latent heat of vaporization needs to be overcome in the pre-heating phase. Therefore, a minimum amount of energy may need to be transferred to the aerosol-forming substrate in order to generate aerosol and it may not be enough just for the heater element to have reached a target temperature. A combination of the fixed first phase and the dynamic second phase may ensure that the minimum energy is transferred to the heater element even if the target temperature is reached very quickly.

Preferably, the second phase start may correspond to the first phase end. In other words, the controller may be configured to progress through the first phase and then the second phase. In this case, the first phase start may correspond to the usage period start.

Alternatively, the first phase start may correspond to the second phase end. In other words, the controller may be configured to progress through the second phase and then the first phase. In this case, the second phase start may correspond to the usage period start.

The plurality of sequential phases may comprise the third phase. In the third phase, the controller may be configured to repeatedly determine a temperature of the heater element to determine a rate of change of the temperature of the heater element. During the third phase, the controller may further be configured to control the supply of power to the heater assembly to maintain the rate of change of the temperature of the heater element at a constant value. The third phase may be particularly advantageous when the aerosol-generating device comprises a temperature sensor for measuring the temperature of the heater element. The temperature sensor may be a separate component.

When the aerosol-generating device comprises a temperature sensor, there may be a lag between the temperature of the heater element changing and that change being registered by the temperature sensor. This may be because it can take time for energy from the heater element to be transferred to the temperature sensor and so the temperature of the temperature sensor may not be representative of the temperature of the heater element. Controlling the supply of power to the heater assembly to maintain a constant rate of change of the temperature may account for the lag because the value of the rate of change may be chosen to allow the temperature of the temperature sensor to follow the actual temperature of the heater element more closely. This may be because the rate of change of the temperature may not be significantly more than the rate of energy transfer from the heater element to the temperature sensor. A suitable range of values for the constant value for the rate of change may be between 1 and 15 degrees Celsius per second. Preferably the constant value for the rate of change may be between 2 and 10 degrees Celsius per second. Even more preferably, the constant value for the rate of change may be about 3 degrees Celsius per second.

By accounting for the lag between the temperature of the heater element changing and that change being registered by the temperature sensor, the third phase may advantageously reduce or minimise the risk of the heater element overheating. Without controlling the rate of change and accounting for lag, the temperature of the heater element could substantially exceed a target temperature by the time the temperature measured by the temperature sensor reaches the target temperature. Implementing the control of the third phase may advantageously address this issue. Reducing or minimising overheating may advantageously prevent damage to the heater assembly and the overheating of the aerosol-forming substrate.

The third phase may be dynamic in length or of fixed length.

The third phase end may be a third predetermined time after the third phase start.

Alternatively, the third phase end may be when the controller determines that the temperature of the heater element is greater than or equal to the third phase target temperature.

Alternatively, the third phase end may be the earlier of the controller determining that the temperature of the heater element is greater than or equal to the third phase target temperature or the controller determining that the time elapsed since the third phase start is equal to or exceeds a third predetermined time.

The plurality of sequential phases may comprise the first phase and the third phase.

The third phase start may correspond to the first phase end.

The plurality of sequential phases may comprise the second phase and the third phase.

The third phase start may correspond to the second phase end.

The plurality of sequential phases may comprise the first phase, the second phase and the third phase. The first, second and third phases may be sequential with one another.

The third phase start may correspond to the second phase end. Alternatively, the third phase start may correspond to the first phase.

A combination of the third phase with at least one of the first phase and second phase may be advantageous, particularly if the third phase is after at least one of the first phase or second phase and each of the phases is part of a pre-heating phase. This may be because, during the first or second phases, the temperature of the heater element may advantageously be heated rapidly, without any specific control related to the rate of change of the temperature. Providing the third phase after the first or second phase may advantageously account for any overheating that occurred during the first or second phase. The third phase may advantageously allow time for the temperature sensor to reach an equilibrium with the heater element after the first or second phase.

Preferably, the first phase temperature target and second phase temperature target may be lower than the third phase temperature target. The first phase temperature target and second phase target temperature may be sufficiently low that, even if the actual temperature exceeds a temperature target because of a lag between the actual and measured temperature, the actual temperature is still lower than a maximum temperature that the heater assembly is designed to operate at. For example, at least one of the first and second phase target temperatures may be at least 10, 20, 30, 40, 50, 60 or 70 degrees Celsius less than the third phase target temperature. The third phase target temperature may still be lower than the maximum temperature that the heater assembly is designed to operate at. So, the actual temperature of the heater element may exceed the first or second phase target temperature by up to 10, 20, 30, 40, 50, 60 or 70 degrees.

In summary, by combining at least one of the first phase and second phase with the third phase, the heater element may advantageously be heated rapidly in reference to a target temperature which is low enough that the risk of overheating is minimal, and then heated more slowly with reference to a higher target temperature during the third phase to avoid further overheating.

The controller may be configured to limit the supply of energy or power to the heater assembly throughout at least one of the first, second and third phases. Herein, “limiting the supply of energy or power to the heater assembly” refers to the at least a portion of the usage session being divided into n sequential time intervals; and wherein the controller is configured to limit energy or power supplied to the heater element during any or each of the n sequential time intervals to a threshold energy or power, as is described above.

The plurality of sequential phases may comprise the first phase and the controller may be configured to limit the supply of power or energy throughout the first phase.

Alternatively or additionally, the plurality of sequential phases may comprise the second phase and the controller may be configured to limit the supply of power or energy throughout the second phase.

Alternatively or additionally, the plurality of sequential phases may comprise the third phase and the controller may be configured to limit the supply of power or energy throughout the third phase.

The controller may be configured to limit the supply of power or energy throughout each of the plurality of sequential phases.

Each of the first, second and third phase target temperatures may be less than 280 degrees Celsius.

Each of the first, second and third phase target temperatures may be between 180 degrees Celsius and 265 degree Celsius.

The first predetermined time may be between 3 seconds and 20 seconds, preferably between 5 and 10 seconds.

The second predetermined time may be between 5 seconds and 15 seconds.

The heater assembly may be configured to externally heat the aerosol-forming substrate.

The aerosol-generating device may further comprise a housing. The housing may define a cavity for receiving the aerosol-forming substrate. The heater assembly may surround at least a portion of the housing defining the cavity. Alternatively, the heater assembly may define at least a portion of the cavity such that the heater assembly is external to the received aerosol-forming substrate.

The heater assembly may be a flexible heater assembly. The heater assembly may comprise at least one layer of flexible support material. The heater element may comprise at least one heater track deposited on to the at least one layer of flexible support material. The at least one heater track may form the heater element. The flexible support material may comprise or consist of polyimide.

Alternatively, the heater assembly may be configured to internally heat the aerosol-forming substrate.

The heater element may be formed on blade configured to penetrate an aerosol-forming substrate.

The heater element may be configured to be resistively heatable. In this case, the heater assembly may be a resistive heating assembly. The heating element of the resistive heating assembly may comprise or be formed from any material with suitable electrical and mechanical properties. Suitable materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, constantan, nickel-, cobalt-, chromium-, aluminium- titanium-zirconium-, hafnium-, niobium-, molybdenum-, tantalum-, tungsten-, tin-, gallium-, manganese- and iron-containing alloys, and super-alloys based on nickel, iron, cobalt, stainless steel, Timetal®, iron-aluminium based alloys and iron-manganese-aluminium based alloys. Timetal® is a registered trade mark of Titanium Metals Corporation. The heater elements may be coated with one or more electrical insulators. Preferred materials for the heater elements may be 304, 316, 304L, 316L, 18SR stainless steel, and graphite.

As used herein, the term ‘aerosol-forming substrate’ relates to a substrate capable of releasing volatile compounds that can form an aerosol. Such volatile compounds may be released by heating the aerosol-forming substrate. An aerosol-forming substrate may conveniently be part of an aerosol-generating article or smoking article.

The aerosol-forming substrate may be a solid aerosol-forming substrate. Alternatively, the aerosol-forming substrate may comprise both solid and liquid components. The aerosol-forming substrate may comprise a tobacco-containing material containing volatile tobacco flavour compounds which are released from the substrate upon heating. Alternatively, the aerosol-forming substrate may comprise a non-tobacco material. The aerosol-forming substrate may further comprise an aerosol former that facilitates the formation of a dense and stable aerosol. Examples of suitable aerosol formers are glycerine and propylene glycol.

The aerosol-forming substrate may comprise a gathered crimpled sheet of homogenised tobacco material. As used herein, the term ‘crimped sheet’ denotes a sheet having a plurality of substantially parallel ridges or corrugations. Alternatively or additionally, the aerosol-forming substrate may comprise strands, strips of sheds of homogenised tobacco material. Preferably, the aerosol-forming substrate may comprise cut homogenized tobacco comprising glycerine. The glycerine may be applied to the cut homogenized tobacco. Preferably, the glycerine may be sprayed onto the homogenised tobacco.

The aerosol-generating system may comprise a cartridge containing an aerosol-forming substrate. The cartridge may be receivable in the chamber of the aerosol-generating device. The aerosol-forming substrate may be solid or liquid or comprise both solid and liquid components. Preferably, the aerosol-forming substrate is a liquid.

The aerosol-forming substrate may comprise plant-based material. The aerosol-forming substrate may comprise tobacco. The aerosol-forming substrate may comprise a tobacco-containing material containing volatile tobacco flavour compounds, which are released from the aerosol-forming substrate upon heating. Preferably, the aerosol-forming substrate may alternatively comprise a non-tobacco-containing material.

In a further aspect, there is provided an aerosol-generating system comprising an aerosol-generating device as described in the any aspect disclosed herein. The aerosol-generating system may further comprise an aerosol-generating article comprising an aerosol-forming substrate.

The aerosol-generating article may be in the form of a rod. The aerosol-forming substrate may be contained in a distal end of the rod. The proximal end of the rod may form or comprise a mouthpiece. In other words, the aerosol-generating article may comprise a mouthpiece.

The aerosol-generating article may comprise a wrapper circumscribing the aerosol-forming substrate.

The aerosol-generating device may comprise a housing defining a cavity for receiving the aerosol-forming article. The cavity may the same as the cavity described in relation to the earlier aspects. In use, when the aerosol-generating article is received in the cavity, the mouthpiece of the aerosol-generating article may protrude out of the cavity. A user may therefore be able to draw air through the aerosol-forming article received in the cavity through the mouthpiece.

In a further aspect, there is provided a method of controlling power supplied to a heater assembly of an aerosol-generating device during a usage session. The aerosol-generating device may comprise the heater assembly. The heater assembly may comprise a heater element for heating an aerosol-forming substrate. The aerosol-generating device may comprise a power supply. The power supply may be configured to supply power to the heater assembly.

The method may comprise dividing at least a portion of the usage session into n sequential time intervals.

The method may further comprising limiting the power supplied to the heater assembly during any or each of the n sequential time intervals. The power may be limited to a threshold average power, as described in relation to other aspects above.

Limiting the power supplied to the heater assembly may comprise limiting power during any or each of the n sequential time intervals such that an average of the power supplied throughout any or each of the n sequential time intervals does not exceed the threshold average power.

The method may comprise limiting the power supplied to the heater assembly during any or each of the n sequential time intervals such that a threshold energy for that time interval is not exceeded. Preferably, a threshold energy may not be exceeded for each of the n sequential time intervals.

The power supply may be a portable power supply for storing energy. A portable power supply may be a battery, for example a rechargeable battery.

The threshold energy may be less than the maximum energy that can be delivered by the power supply during any or each of the n sequential time intervals when the power supply is fully charged. The threshold energy may advantageously be chosen as an amount of energy that the portable power supply can supply in any or each of the n sequential time intervals even after at least 5, at least 10, at least 15 or even at least 20 usages sessions. For example, the threshold energy may be at least 10% lower than the maximum energy. Preferably, the threshold energy may be at least 15% lower than the maximum energy. Even more preferably, the threshold energy may be at least 20% lower than the maximum energy.

The threshold energy may be less than 1 Joule supplied to the heater assembly during any or each of the n sequential time intervals, preferably less than 0.8 Joules, even more preferably less than 0.6 Joules.

The threshold energy may be more than 0.4 Joules, preferably more than 0.45 Joules, even more preferably more than 0.5 Joules.

The threshold power may be less than the maximum power that can be delivered by the power supply during any or each of the n sequential time intervals when the power supply is fully charged. The threshold power may advantageously be chosen as an amount of power that the portable power supply can supply in any or each of the n sequential time intervals even after at least 5, at least 10, at least 15 or even at least 20 usages sessions. For example, the threshold power may be at least 10% lower than the maximum power. Preferably, the threshold power may be at least 15% lower than the maximum power. Even more preferably, the threshold power may be at least 20% lower than the maximum power.

The threshold average power may be less than 13 Watts, preferably less than 12 Watts, even more preferably less than 11 Watts. The threshold average power may be greater than 8 Watts, preferably greater than 9 Watts, even more preferably greater than 10 Watts.

The power supply may store enough power for at least 5 usage sessions, preferably at least 10, even more preferably at least 20 usage sessions.

The step of limiting the power or energy supplied to the heater assembly during any or each of the n sequential time intervals may comprise monitoring a cumulative amount of energy supplied to the heater assembly from the start of the nth time interval

The step of limiting power or energy supplied to the heater assembly during any or each of the n sequential time intervals may further comprise limiting the supply of power or energy to the heater assembly until the end of the nth sequential time interval if the cumulative amount of energy supplied from the start of the nth time interval equals or exceeds the threshold energy. Limiting the supply of power or energy to the heater assembly may consist of stopping the supply of power energy to the heater assembly.

The step of monitoring the cumulative amount of energy supplied to the heater assembly from the start of the nth time interval may comprise measuring the instantaneous power supplied to the heater assembly from the power supply repeatedly during any or each of the n sequential time intervals.

The step of measuring the instantaneous power may comprise determining the voltage and the current being supplied to the heater assembly and multiplying the determine voltage by the determined current. The method may further comprise, for each measurement of instantaneous power, determining the energy supplied to the heater assembly since the previous measurement of instantaneous of power by multiplying the measured instantaneous power by the time elapsed since the previous measurement of instantaneous power. The method may further comprise adding the determined energy to a value representing the cumulative amount of energy.

The steps of the method relating to measuring the instantaneous power and monitoring the cumulative energy may be repeated at least 100 times a second, preferably at least 500 times a second, even more preferably about 1000 times a second.

The method may further comprise, during at least a portion of the usage session, controlling the supply of power to the heater assembly such that the heater element is heated with reference to one or more target temperatures. This may be for the entire usage session.

The step of controlling the supply of power to the heater assembly such that the heater element is heated with reference to one or more target temperatures may comprise performing thermostatic control. Thermostatic control may comprise repeatedly determining the temperature of the heater element and comparing the temperature to the respective target temperature. Thermostatic control may comprise limiting or, preferably, stopping the supply of power to the heater assembly while the determined temperature of the heater element exceeds the respective target temperature. Thermostatic control may comprise supplying power to the heater assembly while the determined temperature of the heater element is less than the respective target temperature.

Thermostatic control may be carried out during the portion of the usage session that is divided into n sequential time intervals.

The usage session may comprise a plurality of sequential phases between a usage session start and a usage session stop. Each of the phases of the plurality of sequential phases may begin at a phase start and ends at a phase end.

The method may further comprise controlling the progress of the usage session through the plurality of sequential phases by determining at least one of: the length of time since the phase start is equal to or exceeds a predetermined duration; and the temperature is equal to or exceeds a target temperature.

The plurality of sequential phases may comprise at least one of a first phase, a second phase and a third phase. The first, second and third phases may be as described above.

The method may comprise ending the first phase a first predetermined time after first phase start.

The method may comprise ending the second phase the earlier of: determining that the temperature of the heater element is greater than or equal to a second phase target temperature, or determining that the time elapsed since the second phase start is equal to or exceeds a second predetermined time.

The method may comprise the repeatedly determining a temperature of the heater element during a third phase to determine a rate of change of the temperature of the heater element. The method may further comprise controlling the supply of power to the heater assembly during the third phase to maintain the rate of change of the temperature of the heater element at a constant value. The constant value may be between 1 and 15 degrees Celsius per second, preferably between 2 and 10 degrees Celsius per second, even more preferably about 3 degrees Celsius per second.

The method may comprise ending the third phase the temperature of the heater element is greater than or equal to a third phase target temperature.

Alternatively, the method may comprise ending the third phase when the time elapsed since the third phase start is equal to or exceeds a third predetermined time.

Alternatively, the method may comprise ending the third phase the earlier of earlier of: the temperature of the heater element being greater than or equal to the third target temperature or the time elapsed since the third phase start being equal to or exceeding a third predetermined time.

In a further aspect, there is a provided a method of using an aerosol-generating device as described above.

In a further aspect there is provided an aerosol-generating device for generating an aerosol from an aerosol-forming substrate. The aerosol-generating device may be configured to generate the aerosol during a usage session. The aerosol-generating device may comprise a timer. The aerosol-generating device may comprise a heater assembly. The heater assembly may comprise a heater element for heating the aerosol-forming substrate. The aerosol-generating device may comprise a power supply. The power supply may be configured to supply energy to the heater element. The aerosol-generating device may comprise a controller.

An aerosol-generating device of any aspect described herein may comprise features described in relation to any other aspect, except where incorporation of such a feature would cause a contradiction with the broadest statement made in relation to that aspect.

In particular, the usage session may progress through a plurality of sequential phases between a usage session start and a usage session stop. Progress of the usage session through the plurality of sequential phase may be by the controller. Each of the phases may begin at a phase start. Each of the phases may end at a phase end. During each phase, the controller may be configured to control the supply of power to the heater assembly such that the heater element is heated with reference to a respective target temperature.

The plurality of sequential phases may comprise a first phase. The first phase may have a first phase target temperature. The first phase end may be a first predetermined time after the first phase start.

The plurality of sequential phases may comprise a second phase. The second phase may have a second phase target temperature. The second phase end may be the earlier of the controller determining that the temperature of the heater element is greater than or equal to the second phase target temperature; or the controller determining that the time elapsed since the second phase start is equal to or exceeds a second predetermined time.

The first and second phases may be as described above. The plurality of sequential phases may further comprise a third phase. The third phase may as described above.

The controller of the aerosol-generating device may further be configured such that at least a portion of the usage session may be divided into n sequential time intervals and to limit energy or power supplied to the heater element during any or each of the n sequential time intervals to a threshold energy or power, respectively. The energy or power limitation may be the same as described above.

The controller may be configured to limit energy or power during at least one of the first and second phases. The controller may be configured to limit energy or power during both of the first and second phase. The controller may be configured to limit energy or power during the entire usage session.

In a further aspect, there is provided a method of controlling the progress of a usage session of an aerosol-generating device through a plurality of sequential phases. Each of the phases may being at a phase start. Each of the phases may end at a phase end.

The aerosol-generating device may be an aerosol-generating device as disclosed in relation to any aspect herein.

The aerosol-generating device may comprise a heater assembly. The heater assembly may comprise a heater element for heating an aerosol-forming substrate. The aerosol-generating device may comprise a power supply. The power supply may be configured to supply energy to the heater assembly.

The method may comprise controlling the supply of power to the heater assembly such that the heater element is heated with reference to a first phase target temperature during a first phase.

The method may comprise ending the first phase such that the first phase end is a first predetermined time after the first phase start.

The method may comprise controlling the supply of power to the heater assembly such that the heater element is heated with reference to a second phase target temperature during a second phase.

The method may comprise ending the second phase at the earlier of: the temperature of the heater element being greater than or equal to the second phase target temperature; or the time elapsed since the second phase start being equal to or exceeding a second predetermined time.

In a further aspect, there is provided a method of using a device according to an aspect described herein.

In a further aspect, there is provided an aerosol-generating device for generating an aerosol from an aerosol-forming substrate. The aerosol-generating device may be configured to generate the aerosol during a usage session. The aerosol-generating device may comprise a timer. The aerosol-generating device may comprise a heater assembly. The heater assembly may comprise a heater element for heating the aerosol-forming substrate. The aerosol-generating device may comprise a power supply. The power supply may be configured to supply energy to the heater element. The aerosol-generating device may comprise a controller.

The aerosol-generating device of this further aspect may comprise any of the features described in relation to the aerosol-generating device of earlier aspects.

In particular, the usage session may progress through a plurality of sequential phases between a usage session start and a usage session stop. Progress of the usage session through the plurality of sequential phase may be by the controller. Each of the phases may begin at a phase start. Each of the phases may end at a phase end. During each phase, the controller may configured to control the supply of power to the heater assembly such that the heater element is heated with reference to a respective target temperature.

The plurality of sequential phases may comprise a first phase. The first phase may have a first phase target temperature. The first phase end may be at least one of: a first predetermined time after the first phase start; or when the controller has determined that the temperature of the heater element is greater than or equal to the first phase target temperature.

The plurality of a sequential phases may comprise a second phase. The second phase may have a second phase target temperature. In the second phase, the controller may be configured to repeatedly determine a temperature of the heater element. The controller may be configured to determine a rate of change of the temperature of the heater element. The controller may be configure to control the supply of power to the heater assembly to maintain the rate of change of the temperature of the heater element at a constant value.

The second phase start may correspond to the first phase end. The first phase start may correspond to the usage session start.

Alternatively, the first phase start may correspond second phase end. The second phase start may correspond to the usage session start.

The first phase end may be the earlier of: the controller determining that the temperature of the heater element is greater than or equal to the first target temperature; or the controller determining that the time elapsed since the second phase start is equal to or exceeds a second predetermined time.

The first phase of this aspect may correspond to the second phase of an earlier aspect, as described above. The second phase of this aspect may correspond to the third phase of the earlier aspect, as described above.

The plurality of sequential phases may further comprise a third phase. The third phase may have a third phase target temperature. The third phase end may be a third predetermined time after the third phase start. The third phase of this aspect may correspond to the first phase of the earlier aspect.

The third phase may be after or before the first phase. The third phase may be after or before the second phase.

The third phase start may correspond to the usage session start. Alternatively, the third phase start may correspond to the first phase end. Alternatively, the third phase start may correspond to the second phase end.

The controller of the aerosol-generating device may further be configured such that at least a portion of the usage session may be divided into n sequential time intervals and to limit energy or power supplied to the heater element during any or each of the n sequential time intervals to a threshold energy or power, respectively. The energy or power limitation may be the same as described above.

The controller may be configured to limit energy or power during at least one of the first and second phases. The controller may be configured to limit energy or power during both of the first and second phase. The controller may be configured to limit energy or power during the entire usage session.

In a further aspect, there is provided a method of controlling the progress of a usage session of an aerosol-generating device through a plurality of sequential phases. Each of the phases may begin at a phase start. Each of the usage phases may end at a phase end.

The aerosol-generating device may be an aerosol-generating device according to the previous aspect.

The aerosol-generating device may comprise a heater assembly. The heater assembly may comprise a heater element for heating an aerosol-forming substrate. The aerosol-generating device may comprise a power supply. The power supply may be configured to supply power to the heater assembly.

The method may comprise controlling the supply of power to the heater assembly such that the heater element is heated with reference to a first phase target temperature during a first phase.

The method may comprise ending the first phase such that the first phase end is a first predetermined time after the first phase start or when the temperature of the heater element is greater than or equal to the first phase target temperature.

The method may comprise controlling the supply of power to the heater assembly such that the heater element is heated with reference to a second phase target temperature during a second phase.

The method may comprise, during the second phase, repeatedly measuring a temperature of the heater element to determine a rate of change of the temperature of the heater element and controlling the supply of power to the heater assembly to maintain the rate of change of the temperature of the heater element at a constant value.

Features described in relation to one aspect may be applied to other aspects of the disclosure.

The invention is defined in the examples. However, below there is provided a non-exhaustive list of non-limiting examples. Any one or more of the features of these examples may be combined with any one or more features of another example, embodiment, or aspect described herein.
EX1. An aerosol-generating device for generating an aerosol from an aerosol-forming substrate, the aerosol-generating device being configured to generate the aerosol during a usage session, the aerosol-generating device comprising:
   a timer;
   a heater assembly comprising a heater element for heating the aerosol-forming substrate;
   a power supply configured to supply energy to the heater assembly; and a controller.
EX1a. An electrically operated aerosol-generating device, the device comprising: a heating chamber configured to at least partially receive an aerosol-generating article comprising an aerosol-forming substrate;
   a heater comprising at least one heating element configured to externally heat the aerosol-forming substrate;
   a power source for providing power to the heating element;
   and electric circuitry for controlling supply of power from the power supply to the at least one heating element, wherein the electric circuitry is arranged to:
   control the power provided to the heating element such that in an initial period power is provided such that the temperature of the heating element increases from an initial temperature to a first temperature, in a second period power is provided such that the temperature of the heating element drops to a second temperature below the first temperature, and in a third period power is provided such that the temperature of the heating element increases to a third temperature higher than the second temperature, in which the first temperature is a temperature of between 230° C. and 270° C.
EX1b. An electrically operated aerosol-generating device according to EX1a in which the aerosol-generating device is configured to generate the aerosol during a usage session.
EX2. An aerosol-generating device according to example EX1 or EX1b, wherein at least a portion of the usage session is divided into n sequential time intervals.
EX3. An aerosol-generating device according to example EX2, wherein the controller is configured is configured to limit the power supplied to the heater assembly during any or each of the n sequential time intervals such that a threshold energy for that time interval is not exceeded.
EX4. An aerosol-generating device according to any one of the preceding examples, wherein the power supply is a portable power supply for storing energy such as a battery, preferably a rechargeable battery.
EX5. An aerosol-generating device according to example EX4, wherein the threshold energy is less than the maximum energy that can be delivered by the power supply during any or each of the n sequential time intervals when the power supply is fully charged.
EX6. An aerosol-generating device according to example EX5, wherein the threshold energy is at least 10% lower than the maximum energy, preferably at least 15% lower than the maximum energy, even more preferably at least 20% lower than the maximum energy.
EX7. An aerosol-generating device according to example EX5 or EX6, wherein the threshold energy is less than 1 Joule supplied to the heater element during any or each of the n sequential time intervals, preferably less than 0.8 Joules, even more preferably less than 0.6 Joules.
EX8. An aerosol-generating device according to any of examples EX5 to EX7, wherein the threshold energy is more than 0.4 Joules, preferably more than 0.45 Joules, even more preferably more than 0.5 Joules.
EX9. An aerosol-generating device according to any one of the preceding examples, wherein the controller is configured to limit the power supplied to the heater element during any or each of the n sequential time intervals to a threshold average power.
EX10. An aerosol-generating device according to example EX9, wherein the threshold average power is an average power supplied during the nth sequential time interval.
EX11. An aerosol-generating device according to example EX9 or EX10, wherein the power supply is a portable power supply, preferably a battery, even more preferably a rechargeable battery.
EX12. An aerosol-generating device according to example EX11, wherein the threshold average power is less than the maximum power that can be delivered by the power supply when the power supply is fully charged.
EX13. An aerosol-generating device according to example EX12, wherein the threshold average power is at least 10% lower than the maximum power, preferably at least 15% lower than the maximum power, even more preferably at least 20% lower than the maximum power.
EX14. An aerosol-generating device according to any one of examples EX9 to EX13, wherein the threshold average power is less than 13 Watts, preferably less than 12 Watts, even more preferably less than 11 Watts.
EX15. An aerosol-generating device according to any one of examples EX9 to EX14, wherein the threshold average power is greater than 8 Watts, preferably greater than 9 Watts, even more preferably greater than 10 Watts.
EX16. An aerosol-generating device according to any one of the preceding examples, wherein the power supply stores enough power for at least 5 usage sessions, preferably at least 10, even more preferably at least 20 usage sessions.
EX17. An aerosol-generating device according to any one of the preceding examples, wherein the controller limiting power supplied to the heater assembly during any or each of the n sequential time intervals comprises the controller being configured to monitor a cumulative amount of energy supplied to the heater assembly from the start of the nth time interval.
EX18. An aerosol-generating device according to example EX17, wherein the controller is further configured to limit the supply of power to the heater assembly until the end of the nth sequential time interval if the cumulative amount of energy supplied from the start of the nth time interval equals or exceeds the threshold energy.
EX19. An aerosol-generating device according to example EX18, wherein limiting the supply of power to the heater assembly consists of stopping the supply of power to the heater assembly.
EX20. An aerosol-generating device according to any one of examples EX17 to EX19, wherein the controller being configured to monitor the cumulative amount of energy comprises the controller being configured to measure the instantaneous power supplied to the heater assembly from the power supply repeatedly during any or each of the n sequential time intervals.
EX21. An aerosol-generating device according to example EX20, wherein measuring the instantaneous power comprises the controller being configured to determine the voltage and the current being supplied to the heater assembly and multiplying the determine voltage by the determined current.
EX22. An aerosol-generating device according to example EX21, further comprising a voltmeter and ammeter and wherein the controller is configured to determine the voltage based on signals from the voltmeter and determine the current based on signals from the ammeter.
EX23. An aerosol-generating device according to example EX20, EX21 or EX22, wherein, for each measurement of instantaneous power, the controller is configured to determine the energy supplied to the heater assembly since the previous measurement of instantaneous of power by multiplying the measured instantaneous power by the time elapsed since the previous measurement of instantaneous power.
EX24. An aerosol-generating device according to example EX23, wherein the controller comprises a memory for storing a value representing the cumulative amount of energy.
EX25. An aerosol-generating device according to example EX24, wherein, for each measurement of instantaneous power, the controller is configured to add the determined energy to the value representing the cumulative amount of energy.
EX26. An aerosol-generating device according to any one of examples EX20 to EX25, wherein the controller is configured to measure the instantaneous power supplied to the heater assembly and monitor the cumulative energy at least 100 times a second, preferably at least 500 times a second, even more preferably about 1000 times a second.
EX27. An aerosol-generating device according to example EX24, EX25 or EX26, wherein the controller is configured to reset the cumulative amount energy at the end of any or each of the n sequential time intervals.
EX28. An aerosol-generating device according to any one of the preceding examples, wherein the end of nth sequential time interval corresponds to the start of the n+1 sequential time interval.
EX29. An aerosol-generating device according to any one of the preceding examples, wherein each of the n sequential time intervals are of equal length.
EX30. An aerosol-generating device according to any one of the preceding examples, wherein the duration of each of the n sequential time intervals is 100 milliseconds or less, more preferably 50 milliseconds or less.
EX31. An aerosol-generating device according to any one of the preceding examples, wherein n is greater than 10, preferably greater than 50, preferably greater than 100, more preferably greater than 1000, even more preferably greater than 5000.
EX32. An aerosol-generating device according to any one of the preceding examples, wherein the portion of the usage session that is divided into n sequential time intervals is at least 5 seconds of the usage session, preferably at least 10 seconds of the usage session, even more preferably at least 15 seconds of the usage session.
EX33. An aerosol-generating device according to any one of the preceding examples, wherein the portion of the usage session that is divided into n sequential time intervals is at least a pre-heating portion of the usage session.
EX34. An aerosol-generating device according to any one of the preceding examples, wherein the portion of the usage session that is divided into n sequential time intervals starts at the usage session start.
EX35. An aerosol-generating device according to any one of the preceding examples, wherein substantially the entire usage session is divided into n sequential time intervals.
EX36. An aerosol-generating device according to any one of the preceding examples, wherein the resistance of the heater element is at least 0.9 ohm.
EX37. An aerosol-generating device according to any one of the preceding examples, further comprising a temperature sensor configured to measure the temperature of the heater element.
EX38. An aerosol-generating device according to any one of the preceding examples, wherein, during at least a portion of the usage session, the controller is configured to control the supply of power to the heater assembly such that the heater element is heated with reference to one or more target temperatures.
EX39. An aerosol-generating device according to example EX38, wherein the controller is configured to control the supply of power to the heater assembly such that the heater element is heated with reference to one or more target temperatures for the entire usage session.
EX40. An aerosol-generating device according to example EX38 or EX39, wherein controlling the supply of power to the heater assembly such that the heater element is heated with reference to one or more target temperatures comprises the controller being configured to perform thermostatic control.
EX41. An aerosol-generating device according to example EX40, wherein the thermostatic control comprises the controller repeatedly determining the temperature of the heater element and comparing the temperature to the respective target temperature.
EX42. An aerosol-generating device according to example EX40 or EX41, wherein the controller is configured to stop the supply of power to the heater assembly while the determined temperature of the heater element exceeds the respective target temperature.
EX43. An aerosol-generating device according to any one of examples EX40 to EX42, wherein the controller is configured to supply power to the heater assembly while the determined temperature of the heater element is less than the respective target temperature.
EX44. An aerosol-generating device according to any one of examples EX40 to EX43, wherein the controller is configured to carry out thermostatic control during the portion of the usage session that is divided into n sequential time intervals.
EX45. An aerosol-generating device according to example EX44, wherein the controller is configured to determine the temperature of the heater tracks and compare the temperature to the respective target temperature multiple times during at least some of the n sequential time intervals.
EX46. An aerosol generating device according to any one of examples EX41 to EX45, wherein the controller is configured to determine the temperature of the heater element and compare the temperature to the respective target temperature at least 100 times a second, preferably at least 500 times a second, even more preferably about 1000 times a second.
EX47. An aerosol generating device according to any one of examples EX41 to EX46, wherein the controller is configured to determine the temperature of the heater element and compare the temperature to the respective target temperature less than 10,000 times a second, preferably less than 5000 times a second.
EX48. An aerosol-generating device according to any one of the preceding examples, wherein the usage session comprises a plurality of sequential phases between a usage session start and a usage session stop.
EX49. An aerosol-generating device according to example EX48, wherein each of the phases of the plurality of sequential phases begins at a phase start and ends at a phase end.
EX50. An aerosol-generating device according to example EX49, wherein the progress of the usage session through the plurality of sequential phases is controlled by the controller.
EX51. An aerosol-generating device according to example EX50, wherein the progress of the usage session through the plurality of sequential phases is controlled by the controller determining at least one of: the length of time since the phase start is equal to or exceeds a predetermined duration; and the temperature is equal to or exceeds a target temperature.
EX52. An aerosol-generating device according to examples EX50 or EX51, wherein, during each phase, the controller is configured to control the supply of power to the heater element such that the heater element is heated in reference to a target temperature.
EX53. An aerosol-generating device according to any one of example EX50 to EX52, wherein the plurality of sequential phases comprises at least one of:
   a first phase having a first phase target temperature and in which the first phase end is a first predetermined time after the first phase start;
   a second phase having a second phase target temperature and in which the second phase end is the earlier of the controller determining that the temperature of the heater element is greater than or equal to the second target temperature or the controller determining that the time elapsed since the second phase start is equal to or exceeds a second predetermined time; and
   a third phase having a third phase target temperature and in which the controller is configured to repeatedly determine a temperature of the heater element to determine a rate of change of the temperature of the heater element.
EX54. An aerosol-generating device according to example EX53, wherein the plurality of sequential phases comprises the first phase.
EX55. An aerosol-generating device according to example EX54, wherein the first phase start corresponds to the usage session start.
EX56. An aerosol-generating device according to example EX54 or EX55, wherein the plurality of sequential phases further comprises the second phase.
EX57. An aerosol-generating device according to example EX56, wherein the second phase start corresponds to the first phase end.
EX58. An aerosol-generating device according to example EX56 or EX57, wherein the plurality of sequential phases further comprise the third phase and the third phase start corresponds to the second phase end.
EX59. An aerosol-generating device according to example EX54 or EX55, wherein the plurality of sequential phases further comprises the third phase.
EX60. An aerosol-generating device according to example EX59, wherein the third phase start corresponds to the first phase end.
EX61. An aerosol-generating device according to example EX53, wherein the plurality of sequential phases comprises the second phase.
EX62. An aerosol-generating device according to example EX61, wherein the second phase start corresponds to usage session start.
EX63. An aerosol-generating device according to example EX61 or EX62, wherein the plurality of sequential phases comprises the third phase.
EX64. An aerosol-generating device according to example EX63, wherein the third phase start corresponds to the second phase end.
EX65. An aerosol-generating device according to example EX53, wherein the plurality of sequential phases comprises the third phase and a fourth phase having a fourth phase target temperature and in which the fourth phase end is a fourth predetermined time after the fourth phase start or when the controller has determined that the temperature of the heater element is greater than or equal to the fourth phase target temperature.
EX66. An aerosol-generating device according to example EX65, wherein the fourth phase is the same as the second phase.
EX67. An aerosol-generating device according to any one of examples EX53 to EX66, wherein, in the third phase, the controller is configured to control the supply of power to the heater assembly to maintain the rate of change of the temperature of the heater element at a constant value.
EX68. An aerosol-generating device according to example EX67, wherein the constant value is between 1 and 15 degrees Celsius per second, preferably between 2 and 10 degrees Celsius per second, even more preferably about 3 degrees Celsius per second.
EX69. An aerosol-generating device according to any one of examples 53 to 66, wherein the third phase end is when the controller determines that the temperature of the heater element is greater than or equal to the third target temperature or when the controller determines that the time elapsed since the third phase start is equal to or exceeds a third predetermined time.
EX70. An aerosol-generating device according to any one of examples EX53 to EX69, wherein the controller is configured to limit the supply of power to the heater assembly throughout at least one of the first, second and third phases.
EX71. An aerosol-generating device according to example EX70, wherein the plurality of sequential phases comprises the first phase and the controller is configured to limit the supply of power throughout the first phase.
EX72. An aerosol-generating device according to example EX71, wherein the controller is configured to limit the supply of power throughout each of the plurality of sequential phases.
EX73. An aerosol-generating device according to any one of examples EX53 to EX72, wherein the third target temperature is greater than at least one of the first and second target temperatures.
EX74. An aerosol-generating device according to any one of examples EX53 to EX73, wherein each of the first, second and third phase target temperatures are less than 280 degrees Celsius.
EX75. An aerosol-generating device according to any one of examples EX53 to EX74, wherein each of the first, second and third target phase temperatures are between 180 degrees Celsius and 265 degree Celsius.
EX76. An aerosol-generating device according to any one of examples EX53 to EX75, wherein the first predetermined time is between 3 seconds and 20 seconds, preferably between 5 and 10 seconds.
EX77. An aerosol-generating device according to any one of examples EX53 to EX76, wherein the second predetermined time is between 5 seconds and 15 seconds.
EX78. An aerosol-generating device according to any one of the preceding examples, wherein the heater assembly is configured to externally heat the aerosol-forming substrate.
EX79. An aerosol-generating device according to any one of the preceding examples, further comprising a housing defining a cavity for receiving the aerosol-forming substrate wherein the heater assembly surrounds at least a portion of the housing defining the cavity or defines at least a portion of the cavity such that the heater assembly is external to the received aerosol-forming substrate.
EX80. An aerosol-generating device according to example EX79, wherein the heater assembly is a flexible heater assembly.
EX81. An aerosol-generating device according to example EX80, wherein the heater assembly comprises at least one layer of flexible support material and wherein the heater element is at least one heater track deposited on to the at least one layer of flexible support material.
EX82. An aerosol-generating device according to example EX81, wherein the flexible support material comprises or consists of polyimide.
EX83. An aerosol-generating device according to any one of examples EX1 to EX77, wherein the heater assembly is configured to internally heat the aerosol-forming substrate.
EX84. An aerosol-generating device according to any one of examples EX1 to EX77, wherein the heater element is formed on blade configured to penetrate an aerosol-forming substrate.
EX85. An aerosol-generating device according to any one of the preceding examples, wherein the heater element is configured to be resistively heatable.
EX86. An aerosol-generating system comprising an aerosol-generating device as defined in any one of the preceding examples and an aerosol-generating article comprising an aerosol-forming substrate.
EX87. An aerosol-generating system according to example EX86, wherein the aerosol-generating article is in the form of a rod.
EX88. An aerosol-generating system according to example EX87, wherein the aerosol-generating article comprises a wrapper circumscribing the aerosol-forming substrate.
EX89. An aerosol-generating system according to any one of examples EX86 to EX88, wherein the aerosol-generating device comprises a housing defining a cavity for receiving the aerosol-forming article.
EX90. A method of controlling power supplied to a heater assembly of an aerosol-generating device during a usage session, the aerosol-generating device comprising a heater assembly comprising a heater element for heating an aerosol-forming substrate and a power supply configured to supply power to the heater assembly; the method comprising:
   dividing at least a portion of the usage session into n sequential time intervals;
   limiting the power supplied to the heater assembly during any or each of the n sequential time intervals such that a threshold energy for that time interval is not exceeded.
EX92. A method according to example EX91, wherein the threshold energy is less than the maximum energy that can be delivered by the power supply during any or each of the n sequential time intervals when the power supply, which is a portable power supply, is fully charged.
EX93. A method according to example EX92, wherein the threshold energy is at least 10% lower than the maximum energy. Preferably, the threshold energy may be at least 15% lower than the maximum energy. Even more preferably, the threshold energy may be at least 20% lower than the maximum energy.
EX94. A method according to any one of examples EX91 to EX93, wherein the threshold average power is at least 10% lower than the maximum power, preferably at least 15% lower than the maximum power, even more preferably at least 20% lower than the maximum power wherein the threshold average power is less than 13 Watts, preferably less than 12 Watts, even more preferably less than 11 Watts.
EX95. A method according to any one of examples EX91 to EX94, wherein the threshold average power is an average power supplied during the nth sequential time interval.
EX96. A method according to any one examples EX91 to EX95, wherein the method comprises limiting the energy supplied to the heater assembly during any or each of the n sequential time intervals to a threshold energy.
EX97. A method according to example EX96, wherein the threshold energy is less than the maximum energy that can be delivered by the power supply when the power supply is fully charged.
EX98. A method according to examples EX96 to EX97, wherein the threshold energy is less than 1 Joule supplied to the heater element during each of the n sequential time intervals, preferably less than 0.8 Joules, even more preferably less than 0.6 Joules.
EX99. A method according to any one of examples EX96 to EX98, wherein the threshold energy is more than 0.4 Joules, preferably more than 0.45 Joules, even more preferably more than 0.5 Joules.
EX100. A method according to any one of examples EX90 to EX99, wherein the step of limiting power supplied to the heater assembly during any or each of the n sequential time intervals comprises monitoring a cumulative amount of energy supplied to the heater assembly from the start of the nth time interval EX101. A method according to example EX100, wherein the step of limiting power supplied to the heater assembly during any or each of the n sequential time intervals further comprises limiting the supply of power to the heater assembly until the end of the nth sequential time interval if the cumulative amount of energy supplied from the start of the nth time interval equals or exceeds the threshold energy.
EX102. A method according to example EX100 or EX101, wherein the step of monitoring the cumulative amount of energy supplied to the heater assembly from the start of the nth time interval comprises measuring the instantaneous power supplied to the heater assembly from the power supply repeatedly during any or each of the n sequential time intervals.
EX103. A method according to example EX102, wherein the step of measuring the instantaneous power comprises determining the voltage and the current being supplied to the heater assembly and multiplying the determine voltage by the determined current.
EX104. A method according to example EX103, wherein the method further comprises, for each measurement of instantaneous power, determining the energy supplied to the heater assembly since the previous measurement of instantaneous of power by multiplying the measured instantaneous power by the time elapsed since the previous measurement of instantaneous power.
EX105. A method according to example EX104, wherein the method further comprises adding the determined energy to a value representing the cumulative amount of energy.
EX106. A method according to any one of examples EX90 to EX105, wherein the method further comprises, during at least a portion of the usage session, controlling the supply of power to the heater assembly such that the heater element is heated with reference to one or more target temperatures.
EX107. A method according to example EX106, wherein the step of controlling the supply of power to the heater assembly such that the heater element is heated with reference to one or more target temperatures comprises performing thermostatic control.
EX108. A method according to example EX107, wherein the thermostatic control comprises repeatedly determining the temperature of the heater element and comparing the temperature to the respective target temperature.
EX109. A method according to example EX108, wherein the thermostatic control comprises limiting or, preferably, stopping the supply of power to the heater assembly while the determined temperature of the heater element exceeds the respective target temperature.
EX110. A method according to example EX108 or EX109, wherein the thermostatic control comprises supplying power to the heater assembly while the determined temperature of the heater element is less than the respective target temperature.
EX111. A method according to any one of examples EX108 to EX110, wherein the thermostatic control is carried out during the portion of the usage session that is divided into n sequential time intervals.
EX112. A method according to any one examples EX90 to EX111, wherein the usage session comprises a plurality of sequential phases between a usage session start and a usage session stop and wherein each of the phases of the plurality of sequential phases begins at a phase start and ends at a phase end.
EX113. A method according to example EX112, wherein the method further comprises controlling the progress of the usage session through the plurality of sequential phases by determining at least one of: the length of time since the phase start is equal to or exceeds a predetermined duration; and the temperature is equal to or exceeds a target temperature.
EX114. A method according to any one of examples EX90 to EX113, wherein the aerosol-generating device is an aerosol-generating device according to any one of examples EX1 to EX 89.
EX114. A method of using an aerosol-generating device according to any one of examples EX1 to EX89.
EX115. An aerosol-generating device for generating an aerosol from an aerosol-forming substrate, the aerosol-generating device being configured to generate the aerosol during a usage session progressing through a plurality of sequential phases between a usage session start and a usage session stop, the aerosol-generating device comprising:
   a timer;
   a heater assembly comprising a heater element for heating the aerosol-forming substrate;
   a power supply configured to supply power to the heater assembly; and
   a controller;
   in which progress of the usage session through the plurality of sequential phases is controlled by the controller, each of the phases beginning at a phase start and ending at a phase end and during which the controller is configured to control the supply of power to the heater assembly such that the heater element is heated with reference to a respective target temperature;
   wherein the plurality of sequential phases comprise:
   a first phase having a first phase target temperature and in which the first phase end is a first predetermined time after the first phase start; and
   a second phase having a second target temperature and in which the second phase end is the earlier of the controller determining that the temperature of the heater element is greater than or equal to the second phase target temperature or the controller determining that the time elapsed since the second phase start is equal to or exceeds a second predetermined time.
EX116. A method of controlling the progress of a usage session of an aerosol-generating device through a plurality of sequential phases, each of the phases beginning at a phase start and ending at a phase end, the aerosol-generating device comprising a heater assembly comprising a heater element for heating an aerosol-forming substrate and a power supply configured to supply power to the heater assembly, the method comprising:
   controlling the supply of power to the heater assembly such that the heater element is heated with reference to a first phase target temperature during a first phase;
   ending the first phase such that the first phase end is a first predetermined time after the first phase start;
   controlling the supply of power to the heater assembly such that the heater element is heated with reference to a second phase target temperature during a second phase;
   ending the second phase at the earlier of:
      the temperature of the heater element being greater than or equal to the second phase target temperature; or
      the time elapsed since the second phase start being equal to or exceeding a second predetermined time.
EX117. An aerosol-generating device for generating an aerosol from an aerosol-forming substrate, the aerosol-generating device being configured to generate the aerosol during a usage session progressing through a plurality of sequential phases between a usage session start and a usage session stop, the aerosol-generating device comprising:
   a timer;
   a heater assembly comprising a heater element for heating the aerosol-forming substrate;
   a power supply configured to supply power to the heater assembly; and
   a controller;
   in which progress of the usage session through the plurality of sequential phases is controlled by the controller, each of the phases beginning at a phase start and ending at a phase end and during which the controller is configured to control the supply of power to the heater assembly such that the heater element is heated with reference to a respective target temperature;
   wherein the plurality of sequential phases comprise:
   a first phase having a first phase target temperature and in which the first phase end is a first predetermined time after the first phase start or when the controller has determined that the temperature of the heater element is greater than or equal to the first phase target temperature; and
   a second phase having a second phase target temperature and in which the controller is configured to repeatedly measure a temperature of the heater element based on signals received from the temperature sensor to determine a rate of change of the temperature of the heater element and to control the supply of power to the heater assembly to maintain the rate of change of the temperature of the heater element at a constant value.
EX118. An aerosol-generating device according to example EX117, wherein the first phase end is the earlier of the controller determining that the temperature of the heater element is greater than or equal to the first target temperature or the controller determining that the time elapsed since the second phase start is equal to or exceeds a second predetermined time.
EX119. A method of controlling the progress of a usage session of an aerosol-generating device through a plurality of sequential phases, each of the phases beginning at a phase start and ending at a phase end, the aerosol-generating device comprising a heater assembly comprising a heater element for heating an aerosol-forming substrate and a power supply configured to supply power to the heater assembly, the method comprising:
   controlling the supply of power to the heater assembly such that the heater element is heated with reference to a first phase target temperature during a first phase;
   ending the first phase such that the first phase end is a first predetermined time after the first phase start or when the temperature of the heater element is greater than or equal to the first phase target temperature;
   controlling the supply of power to the heater assembly such that the heater element is heated with reference to a second phase target temperature during a second phase;
   during the second phase, repeatedly measuring a temperature of the heater element to determine a rate of change of the temperature of the heater element and controlling the supply of power to the heater assembly to maintain the rate of change of the temperature of the heater element at a constant value.

Examples will now be further described with reference to the figures in which:

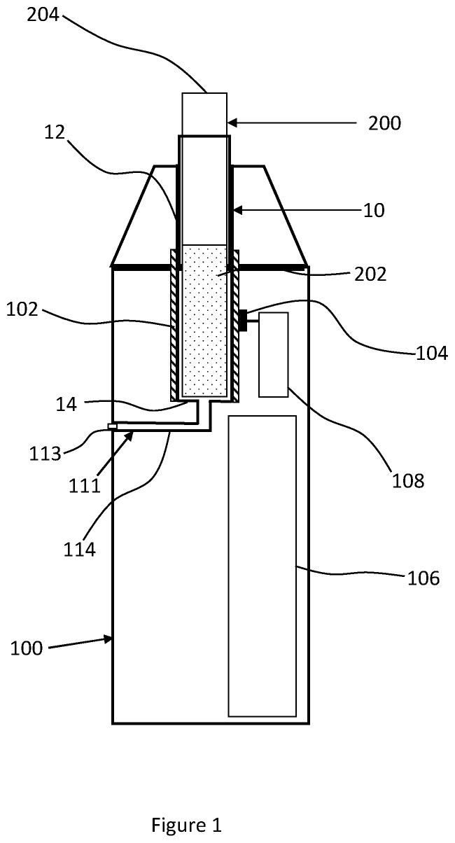

FIG. 1 is a schematic of a cross sectional view of an aerosol-generating device;

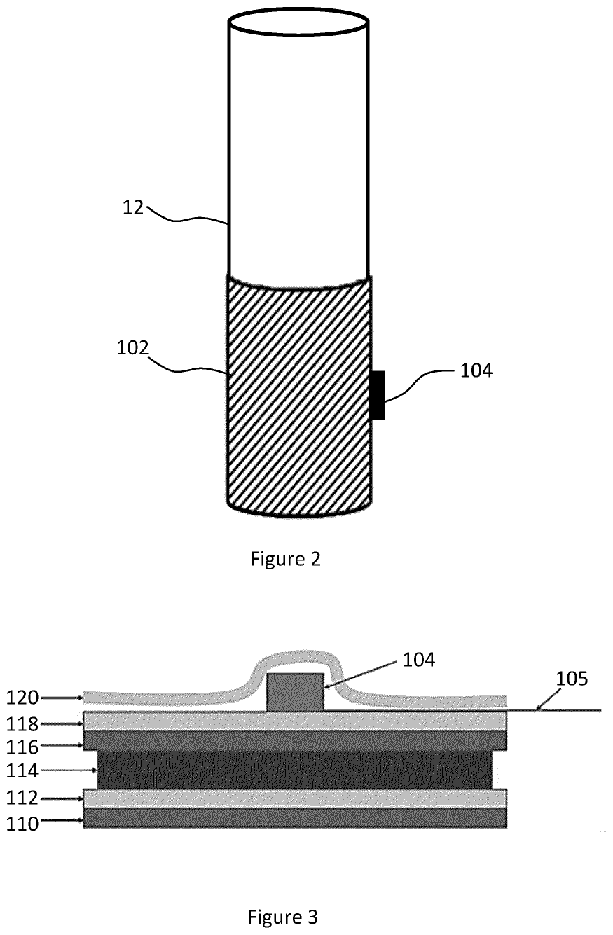

FIG. 2 shows a perspective view of certain features of the aerosol-generating device of FIG. 1 isolated from the rest of the device;

FIG. 3 is a cross-sectional schematic view of a heater assembly of the aerosol-generating device;

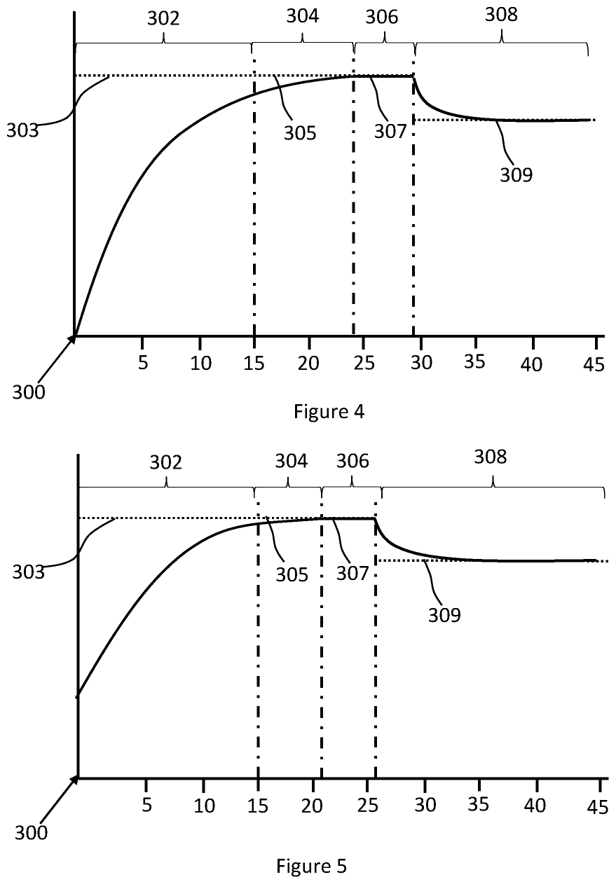

FIG. 4 is a graph representing the temperature of heater tracks of the heater assembly of FIG. 3 against time during a portion of a first embodiment of a heating routine that can be implemented by a controller of the aerosol-generating device;

FIG. 5 is a similar graph to FIG. 4 but where the starting temperature of the heater tracks is higher than in FIG. 4,

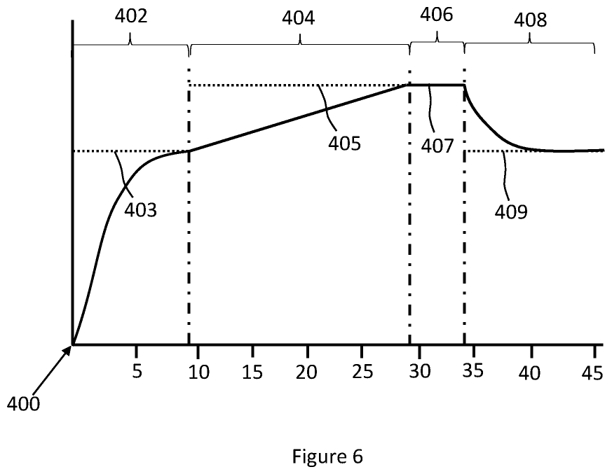

FIG. 6 is a graph representing the temperature of the heater tracks against time during a portion of a second embodiment of a heating routine that can be implemented by a controller of the aerosol-generating device;

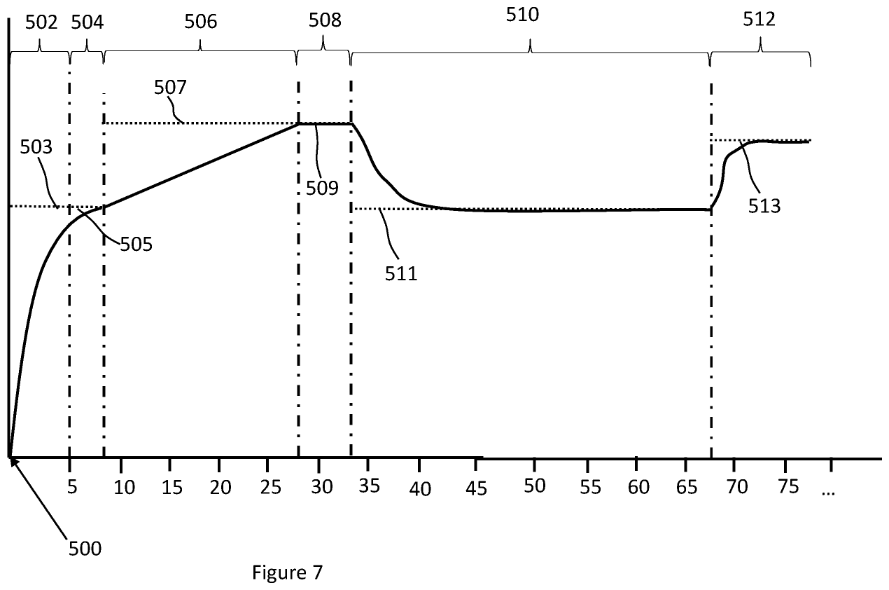

FIG. 7 is a graph representing the temperature of the heater tracks against time during a portion of a third embodiment of a heating routine that can be implemented by a controller of the aerosol-generating device;

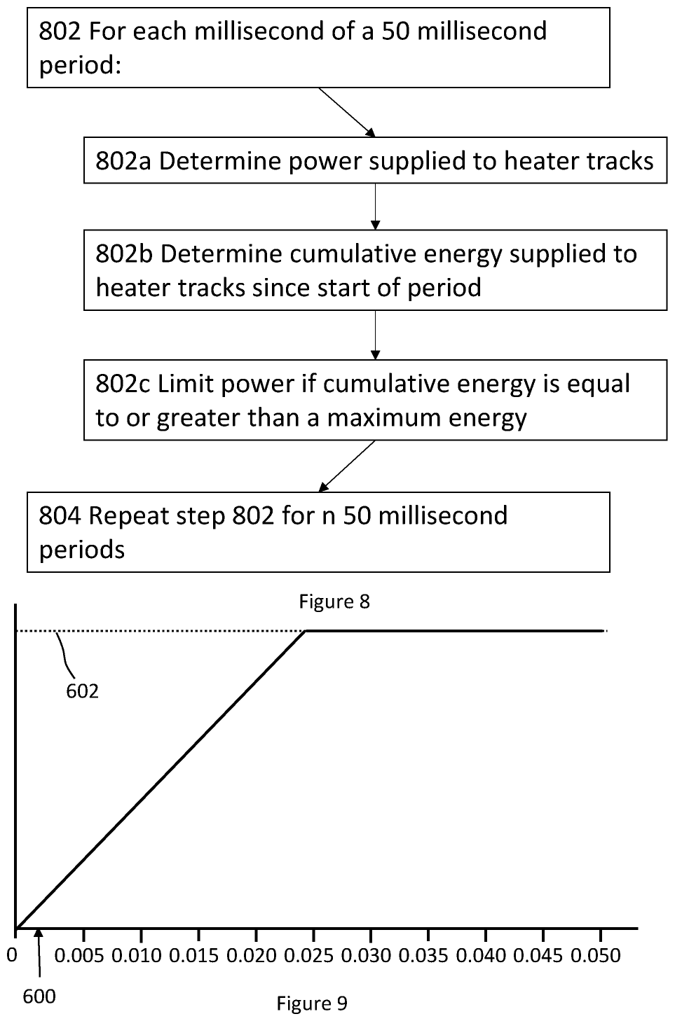

FIG. 8 is a flow diagram showing a method of controlling the average power supplied during a 50 millisecond period;

FIG. 9 is a graph representing the cumulative energy supplied to the heater tracks during the 50 millisecond period of FIG. 8, while the method of FIG. 8 is carried out;

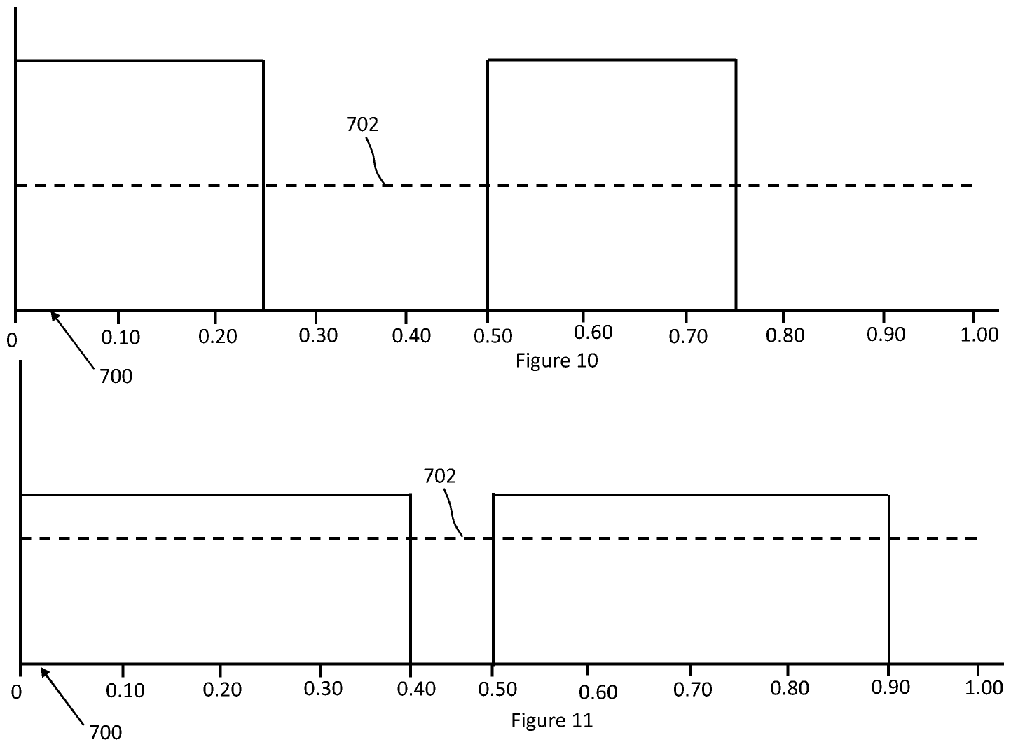

FIG. 10 is a graph representing the power supplied to the heater tracks during the same 50 millisecond period is an in FIG. 9 and when the power supply is fully charged; and

FIG. 11 is a graph representing the power supplied to the heater tracks during the same 50 millisecond period is an in FIG. 9 and when the power supply is not fully charged.

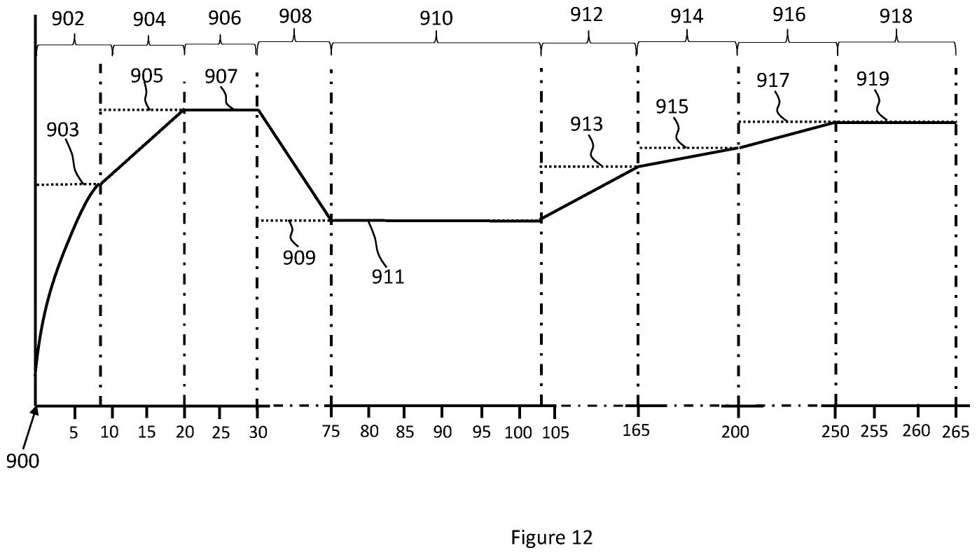

FIG. 12 is a graph illustrating a heating profile applied by an aerosol-generating device according to the embodiment of FIG. 1, to an aerosol-forming substrate of an aerosol-generating article during a usage session.

FIG. 1 is a schematic of a cross sectional view of a first aerosol-generating device 100. The aerosol-generating device 100 comprises a cavity 10 for receiving an aerosol-generating article 200. The cavity 10 is formed by a stainless steel tube 12 and has at an upstream end a base 14.

An aerosol-generating article 200 is received in the cavity 10. The aerosol-generating article 200 contains an aerosol-forming substrate 202. The aerosol-forming substrate 202 is a solid tobacco-containing substrate. In particular, the aerosol-forming substrate 202 is formed from cut sheet of homogenised tobacco. As shown in FIG. 1, the aerosol-generating article 200 and stainless steel tube 12 are configured such that a mouth end of the aerosol-generating article 200 protrudes out of the cavity 10 and out of the aerosol-generating device when the aerosol-generating article is received in the cavity 10. This mouth end forms a mouthpiece 204 on which a user of the aerosol-generating device may puff in use.

An aerosol-generating device 100 together with an aerosol-generating article 200 may be referred to as an aerosol-generating system.

The aerosol-generating device 100 further comprises a heater assembly 102. The heater assembly 102 is a multi-layer flexible heater assembly. The layers of the heater assembly 102 are shown more clearly in FIG. 3, as described below. The heater assembly 102 is bent around an upstream end of the stainless steel tube 12 to surround the upstream end. The portion of the stainless steel tube 12 surrounded by the heater assembly 102 corresponds to the portion of the cavity in which the aerosol-forming substrate 202 of the aerosol-generating article 200 is received when the aerosol-generating article 200 is received in the cavity 10.

The heater assembly 102 further comprises a temperature sensor 104. The temperature sensor 104 is a Pt1000 type temperature sensor. The temperature sensor 104 is in thermal contact with heater tracks of the heater assembly 102 and is configured to measure the temperature of the heater tracks of the heater assembly 102.

FIG. 2 more clearly shows the tubular nature of the stainless steel tube 12 with the heater assembly 102, including temperature sensor 104, wrapped around a lower portion of the stainless steel tube 12. The stainless steel tube 12 and heater assembly 102 are shown separately from the rest of the features of the aerosol-generating system in FIG. 2.

FIG. 3 is a cross-sectional schematic view of the heater assembly 102 and shows the various layers of the heater assembly. The thickness of each of the layers is not drawn to scale. From the bottom to the top, the layers are as follows: a first adhesive layer 110, a first polyimide substrate layer 112, heating tracks 114, a second adhesive layer 116, a second polyimide layer 118 and a heat shrink layer 120. The temperature sensor 104 is positioned between the second polyimide layer 118 and the heat shrink layer 120. The temperature sensor 104 comprises connection wires 105 for connecting the temperature sensor 104 to the controller 108.

The first adhesive layer 110 is used to adhere the heater assembly 102 to the stainless steel tube 12. Sandwiching the heater tracks 114 between the first and second polyimide layers 112, 118 provides a means of supporting the heater tracks 114 in place and provides electrical insulation between the heater tracks 114 and other components of the aerosol-generating device 100, particularly the stainless steel tube 12. Polyimide is advantageously flexible, electrically insulating and able to withstand the normal operation temperatures of the aerosol-generating device, in particular the heater tracks 114, in use.

The heater tracks 114 are continuous, electrically conductive tracks of stainless steel that are deposited on one of the first or second polyimide layers 118 during manufacture. The heater tracks 114 are configured to heat up when an electrical current is passed through them. In other words, the heater assembly 102 is a resistively heated heater assembly 102. The heater tracks 114 have a resistance of 1.1 ohms at room temperature.

The second adhesive layer 116 holds together the first and second polyimide layers 112, 118 which maintains the heater tracks 114 in place.

The heat shrink layer 120 comprises a material that can withstand the normal operation temperatures of the aerosol-generating device, in particular the heater tracks 114, in use. During manufacture, the heat shrink layer 120 is added on top of the components of the heater assembly 102 after they have been wrapped around and adhered to the stainless steel tube 12. The heat shrink layer 120 is heated to a temperature of about 320 degrees Celsius as part of the manufacture process. This firmly maintains the temperature sensor 104 in intimate contact with the second polyimide layer 118, and so in close thermal contact with the heater tracks 114.

The aerosol-generating device 100 further comprises a power supply 106 in the form of a rechargeable battery. The power supply 106 and the temperature sensor 104 of the heater assembly 102 are connected to a controller 108 of the aerosol-generating device 100 via electrical wires and connections not shown completely in the Figures. The power supply 106 is configured to power the heater assembly 102 and is connected to connectors of the heater tracks 102, not shown in the Figures. The heating of the heater assembly 102 by the power supply 106 is controlled by the controller 108.

The controller 108 further comprises a timer not shown in the Figures.

An airflow channel 111 extends from an air inlet 113 of the aerosol-generating device 100. Upstream of the cavity, the airflow channel 111 is primarily defined by an airflow channel wall 114. Downstream of the airflow channel wall 114, the airflow channel 111 passes through an air inlet defined in the base 14 of the cavity. The airflow channel 111 then extends through the cavity 10. When an aerosol-generating article 200 is received in the cavity 10, the airflow channel 111 passes through the aerosol-generating article 200 and extends through the mouthpiece 204.

The aerosol-generating device may comprise further elements, not shown in the Figures, such as a button for activating the aerosol-generating device.

During use of the aerosol-generating system, an aerosol-generating article 200 is inserted to the cavity 10 by a user of the system. The user then activates the device. This may be by, for example, pressing a button or inhaling through the mouthpiece 204 of the aerosol-generating article which is detected by a puff sensor, not shown in the Figures.

Following activation, the controller 108 is configured to control the supply of power from the power supply 106 to the heater assembly 102 to cause the heating tracks 114 to heat up. The heat from the heating tracks 114 is conducted to the aerosol-forming substrate 202 of the aerosol-generating article 200 through the stainless steel tube 12. This heating of the aerosol-forming substrate 202 results in vapour being generated that is released into air drawing into the aerosol-forming article 200 via the airflow channel 111. The vapour then cools and condenses into an aerosol. Thus, when a user inhales through the mouthpiece, the generated aerosol is drawn through the aerosol-forming article 200 to be inhaled by a user.

The control of the heating by the controller 108 is based on temperature signals received from the temperature sensor 104 and timing signals received from the timer, as will be described in more detail below. The controller 108 is additionally or alternatively configured to limit the average power supplied by the power supply 106 so as to not to exceed a predetermined power level, as will also be described in more detail below.

FIG. 4 shows a graph 300 representing a first embodiment of a portion of a heating routine that can be implemented by the controller 108 whereby the controller controls heating based on temperature and timing signals. The X axis of the graph shows time in seconds. Zero on the X axis (t=0) represents the start of a usage session of the aerosol-generating device beginning with a user activating the aerosol-generating device. The Y axis of the graph represents temperature. In particular, the Y axis of the graph represents the temperature of the heating tracks 114, as measured by the temperature sensor 104.

The portion of the heating routine of FIG. 4 comprises four sequential phases.

The first phase 302 begins at 0 seconds. The first phase 302 is of fixed duration with the first phase end being 15 seconds after the first phase start. Throughout the first phase 302, the controller 108 is configured to heat the heater tracks 114 toward a first target temperature of 250 degrees Celsius. 250 degrees Celsius is represented by line 303 on FIG. 4. When heating towards the first target temperature 303, the controller 108 is configured to repeatedly monitor the temperature of the heater tracks 114 measured by the temperature sensor 104. If the controller 108 determines that the measured temperature is less than the target temperature 303 then the controller 108 continues to supply power to the heater assembly 102. If the controller 108 determines that the measured temperature is equal to or exceeds the target temperature 303 than the controller stops the supply of power to the heater assembly 102 until the measured temperature falls below the target temperature. The controller is configured to determine the measured temperature and compare that measured temperature to the target temperature every millisecond.

In other words, the controller 108 is configured to perform thermostatic control of the heater assembly 102. In the first phase 302, the target temperature for the thermostatic control is the first target temperature 303, i.e. 250 degrees Celsius.

When the controller 108 determines that the 15 seconds of the first phase 302 have elapsed it is configured to progress to the second phase 304. So, the second phase start corresponds to the first phase end. Throughout the second phase 304, the controller 108 is configured to heat the heater tracks toward a second target temperature which, in this case, is also 250 degrees Celsius as represented by line 305.

The second phase 304 is dynamic in length. If, at any time during the second phase 304, the controller 108 determines that the temperature of the heater tracks 114, as measured by the temperature sensor 104, exceeds the second target temperature 305, then the controller 108 is configured to progress to the third phase 306. However, the second phase 304 has a maximum length of ten seconds and so the second phase end is, at the latest, ten seconds after the second phase start or 25 seconds from the beginning of the usage session. If the maximum ten seconds of the second phase 304 elapse before the controller determines that the temperature of the heater tracks 114 exceeds the second target temperature 305, the controller will progress to the third phase 306 regardless. In FIG. 4, the controller 108 has determined that the heater tracks 114 reached the second target temperature 305 nine seconds after the second phase start, i.e. slightly before the maximum length of the second phase 304. Therefore, the second phase end is about nine seconds after the first phase end, rather than the maximum ten seconds, or 24 seconds from the start of the usage phase.

The third phase start corresponds to the second phase end. The third phase 306 has a fixed duration with the third phase end being 5 seconds after the third phase start or, in this case, 29 seconds from the start of the usage phase. Throughout the third phase 306, the controller is configured to heat the heater tracks 114 toward a third target temperature which, like the first and second target temperature, is 250 degrees Celsius as represented by line 307 in FIG. 4. In the third phase 306, thermostatic control is used to maintain the heater tracks 114 at the third target temperature 307.

When the controller 108 determines that the five seconds of the third phase 306 have elapsed, the controller 108 is configured to move to the fourth phase 308. So, the fourth phase start corresponds to the third phase end. Throughout the fourth phase 308, the controller 108 is configured to heat the heater tracks 114 toward a fourth target temperature of 190 degrees Celsius, again using thermostatic control. 190 degrees Celsius is represented by line 309 in FIG. 4. As the fourth target temperature 309 is less than the third target temperature 309, power is not initially supplied to the heater assembly 102 as the heater tracks 114 have a temperature above the fourth target temperature 309. Once the heater tracks 114 have cooled to 190 degrees Celsius the heater tracks 114 will be maintained at the temperature by thermostatic control.

In FIG. 4, the initial temperature of the heater assembly 102 is ambient or room temperature. FIG. 5 shows the temperature of the heater assembly 102 when the same heating routine is applied as in FIG. 4 but where the initial temperature of the heater assembly 102 is above ambient or room temperature. This may be the case if the current usage session occurs shortly after a previous usage session such that the heater assembly 102 has not completely cooled down to ambient or room temperature, for example.

In FIG. 5, the decisions made by the controller 108 to progress through each of the phases based on timing and temperature signals are the same as in FIG. 4. However, because the initial temperature is higher in FIG. 5, the resulting temperature profile of the heater tracks 114 when applying the same heating routine as in FIG. 4 is different.

Because the initial temperature is higher in FIG. 5 than FIG. 4, the measured temperature of the heater tracks 114 is much closer to the first target temperature 303 by the first phase end. This means that during the second phase 304 (which is dynamic in duration) the heater tracks 114 reach the second target temperature 305 more quickly than in FIG. 4; only 6 seconds after the second phase start or 21 seconds from the usage session start. Therefore, in FIG. 5, the second phase 304 is shorter than in FIG. 4. The third phase 306 is of fixed duration between the third phase start and third phase end and so in both FIG. 4 and FIG. 5, the third phase ends five seconds after it starts. However, because of the shorter second phase in FIG. 5, the third phase ends 26 seconds from the usage session start rather than 29 seconds as in FIG. 4.

The first, second and third phases 302, 304 and 306 correspond to a pre-heating phase. The pre-heating phase is that in which the heater assembly 102 increases temperature from an initial temperature at the start of a usage session to a temperature at which substantial aerosol is generated. So, the total duration of the first, second and third phases 302, 304 and 306 corresponds to a total amount of time the user of the device may need to wait before substantial aerosol is generated and so before the aerosol-generating device is ready for the user to puff on. It is desirable for the pre-heating phase to be as short as possible. As is demonstrated by FIGS. 4 and 5, the advantage of the dynamic second phase 304 is that the early heating phase is shorter when the initial temperature of the heater tracks at t=0 is higher.

A shorter pre-heating phase also has the advantage that the battery is depleted to lesser extent.

Releasing vapour from the aerosol-forming substrate requires not only for the temperature of the aerosol-forming substrate to be raised but also for substantial energy to be transferred to the aerosol-forming substrate 202 from the heater assembly 102 as latent heat of vaporization. Including first and third phases having fixed durations in the early heating phase provides a minimum amount of time that power is supplied to the heater assembly 102 during the early heating phase and so provides a minimum amount of energy that is transferred to the aerosol-forming substrate 202. This minimum amount of energy accounts for the latent heat of vaporization.

The fourth phase 308 of FIGS. 4 and 5 represents heating after the pre-heating phase during a main phase of the usage session, throughout which substantial amounts of aerosol are generated and throughout which a user can take one or more puffs on the aerosol-generating article. As above, FIGS. 4 and 5 only show a beginning portion of a usage session. The usage session is typically much longer than the portion shown in FIGS. 4 and 5, usually about four and a half minutes. In some embodiments, the fourth phase 308 will continue throughout the entire main phase. However, in other embodiments there may be any number of further sequential phases making up the main phase, each having different target temperatures to provide a desired experience for the user and to suit the type of aerosol-forming substrate being heated. For example, in some embodiments, the target temperature of one or more sequential phases after the fourth phase can increase to account for depletion of the aerosol-forming substrate and so ensure consistent aerosol generation throughout a usage session.

In FIGS. 4 and 5, the first, second and third target temperatures 303, 305 and 307 are all 250 degrees Celsius. However, in other embodiments, different target temperatures may be chosen.

Furthermore, the fixed durations of the first and third phases 302 and 306, and the maximum duration of the second phase 304, can be different. In one embodiment, the fixed duration of the first phase 302 is 8 seconds, the second phase 304 maximum duration is 6 seconds and the third phase 306 is 20 seconds.

FIG. 6 shows a graph 400 representing a second embodiment of a portion of a heating routine implemented by the controller 108 whereby the controller 108 controls heating based on temperature and timing signals. The X axis of the graph 400 shows time in seconds. Zero on the X axis (t=0) represents the start of a usage session of the aerosol-generating device 100. The Y axis of the graph 400 represents temperature. In particular, the Y axis of the graph 400 represents the temperature of the heating tracks 114, as measured by the temperature sensor 104.

The portion of the heating routine of FIG. 6 comprises four sequential phases.

The first phase 402 is dynamic in length. If, at any time during the first phase 402 the controller 108 determines that the temperature of the heater tracks 114, as measured by the temperature sensor 104, exceeds a first target temperature of 190 degrees Celsius then the controller 108 is configured to progress to the second phase 404. The first target temperature is represented by line 403 in FIG. 6. However, the first phase 402 has a maximum length of ten seconds and so the second phase end is, at the latest, ten seconds after the second phase start. If the ten seconds of the first phase 402 elapse before the controller 108 determines that the temperature of the heater tracks 114 exceeds the first target temperature 403, the controller 108 will progress to the second phase 404 regardless. In FIG. 6, the controller 108 has determined that the heater tracks 114 reached the first target temperature 403 slightly before the maximum length of the first phase 402. Therefore, the first phase end is about nine seconds after the first phase end, rather than the maximum ten seconds.

Throughout the second phase 304 the controller is configured to heat the heater tracks 114 toward a second target temperature of 250 degrees Celsius, represented by line 405 in FIG. 6. The controller is configured such that the heating results in a constant rate of change of the temperature of the heater tracks 114 of 3 degrees Celsius per second. In particular, the controller 108 is configured to repeatedly measure a temperature of the heater tracks 114 based on signals received from the temperature sensor 104. Based on these signals, the controller 108 is configured to determine a rate of change of the temperature of the heater tracks and to control the supply of power to the heater assembly 102 to maintain the rate of change of the temperature of the heater tracks at a constant value of 3 degrees Celsius per second. If the determined rate of change of the temperature of the heater tracks is lower than 3 degrees per second, the controller is configured to increase the power supplied to the heater assembly 102. If the determined rate of change of the temperature of the heater tracks is higher than 3 degrees Celsius the controller is configured to reduce the power supplied to the heater assembly 102.

Once the controller 108 has determined that the measured temperature of the heater tracks 114 has reached the second target temperature 405, the controller 108 is configured to move to the third phase 406. In other words, the second phase end is when the controller 108 has determined that the measured temperature of the heater tracks 114 has reached the second target temperature 405.

The third phase 406 is of fixed duration. The third phase end is 5 seconds after the third phase start and the third phase start corresponds to the second phase end. In the third phase 406, the controller is configured to maintain the measured temperature of the heater tracks 114 at a third target temperature, also of 250 degrees as represented by line 407 in FIG. 6.

At the end of third phase 406, the controller 108 is configured to move to a fourth phase 408 in which the controller is configured to maintain the heater tracks 114 at a temperature of 190 degrees Celsius, as represented by line 409 in FIG. 6.

In the second embodiment, the first, second and third phases 402, 404 and 406 may be referred to as the early heating phase.

Controlling the heating such that the rate of change of the temperature measured by the temperature sensor 104 is constant accounts for any differences between the actual temperature of the heater tracks 114 and the temperature measured by the temperature sensor 104. The temperature measured by the temperature sensor 104 will typically be lower than the actual temperature of the heater tracks 114, particular while the heater tracks 114 are increasing in temperature. This is because it takes time for energy from the heater tracks 114 to be transferred to temperature sensor 104 such that the temperatures of two equilibrate. Maintaining the rate of change of measured temperature at a constant 3 degrees Celsius per second avoids the temperature of the heater tracks 114 substantially overshooting the second target temperature and overheating.

The heater assembly 102 is designed to operate up to about 280 degrees Celsius. Overheating may occur if the actual temperature of the heater assembly, and particularly the heater tracks 114, substantially exceeds 280 degrees Celsius. Avoiding overheating of the heater tracks 114 prevents damage to the heater assembly 102.

Providing a third phase 406 in which the heater tracks 114 are maintained at the third target temperature 407 allows further time for the actual temperature of the heater assembly 102 to equilibrate with the measured temperature.

FIG. 7 shows a graph 500 representing a third embodiment of a portion of a heating routine implemented by the controller 108 whereby the controller 108 controls heating based on temperature and timing signals. The third embodiment combines features of both the first and second embodiments. The X axis of the graph 500 shows time in seconds. Zero on the X axis (t=0) represents the start of a usage session of the aerosol-generating device 100. The Y axis of the graph 500 represents temperature. In particular, the Y axis of the graph 500 represents the temperature of the heating tracks 114, as measured by the temperature sensor 104.

The portion of the heating routine of FIG. 7 comprises six sequential phases. The first and second phases 502 and 504 of the third embodiment are similar to the first and second phases 202 and 204 of the first embodiment. The target temperature of the first and second phases 502 and 504 is 190 degrees Celsius, as represented by lines 503 and 505 in FIG. 7, rather than 250 degrees Celsius as in the first embodiment. Furthermore, fixed duration of the first phase 502 of the third embodiment is shorter than the first embodiment. The fixed duration of the first phase 502 is 5 seconds. As such, the first phase 502 begins at 0 seconds and the first phase end is 5 seconds after the first phase start. During the first phase 502, the controller is configured to use thermostatic control to reach the first target temperature 503 of 190 degrees Celsius.

When the controller 108 determines that the 5 seconds of the first phase 502 have elapsed, it is configured to move to the second phase 504. So, the second phase start corresponds to the first phase end.

The second phase 504 is dynamic in length. If, at any time during the second phase 504, the controller 108 determines that the temperature of the heater tracks 114, as measured by the temperature sensor 104, exceeds the second target temperature 505, then the controller 108 is configured to progress to the third phase 506. However, the second phase 504 has a maximum length of ten seconds and so the second phase end is, at the latest, ten seconds after the second phase start or 15 seconds from the beginning of the usage session. If the ten seconds of the second phase elapse before the controller 108 determines that the temperature of the heater tracks 114 exceeds the second target temperature 505, the controller 108 will move to the third phase 506 regardless. In FIG. 7, the controller 108 has determined that the heater tracks 114 reached the second target temperature 505 three seconds after the second phase start, i.e. before the maximum length of the second phase. Therefore, the second phase end is about three seconds after the first phase end, rather than the maximum ten seconds. At the end of the second phase 504, the controller 108 is configured to progress to the third phase 506.

In the third phase 506, the controller 108 is configured to implement the type of control described in relation to the second phase 304 of the second embodiment. In particular, throughout the third phase 506, the controller 108 is configured to heat the heater tracks 114 toward a third target temperature of 250 degrees Celsius, represented by line 507 in FIG. 7, but in such a way that the rate of change of the temperature of the heater tracks 114 is constant. As described in relation to FIG. 6, the controller 108 is configured to repeatedly measure a temperature of the heater tracks 114 based on signals received from the temperature sensor 104. Based on these signals, the controller 108 is configured to determine a rate of change of the temperature of the heater tracks 114 and to control the supply of power to the heater assembly 102 to maintain the rate of change of the temperature of the heater tracks 114 at a constant value of 3 degrees Celsius per second. If the determined rate of change of the temperature of the heater tracks 114 is lower than 3 degrees per second, the controller 108 is configured to increase the power supplied to the heater assembly 102. If the determined rate of change of the temperature of the heater tracks 114 is higher than 3 degrees Celsius the controller 108 is configured to reduce the power supplied to the heater assembly 102.

Once the controller 108 has determined that the measured temperature of the heater tracks 114 has reached the third target temperature 507 of 250 degrees Celsius, the controller 108 is configured to move to the fourth phase 508. In other words, the third phase end is when the controller 108 has determined that the measured temperature of the heater tracks 114 has reached the third target temperature 507.

The fourth phase 508 is of fixed duration. The fourth phase end is five seconds after the fourth phase start and the fourth phase start corresponds to the third phase end. In the fourth phase 508, the controller 108 is configured to maintain the measured temperature of the heater tracks 114 at a fourth target temperature, also of 250 degrees and represented by line 509 in FIG. 7.

At the end of fourth phase 508, the controller 108 is configured to move to a fifth phase 510 in which the controller 108 is configured to maintain the heater tracks 114 at a temperature of 190 degrees Celsius. The fifth phase start corresponds to the fourth phase end. The fifth phase 510 is of fixed duration. The fifth phase end is 40 seconds after fifth phase start. In the fifth phase 510, the controller is configured to maintain the measured temperature of the heater tracks 114 at the fifth target temperature of 190 degrees, represented by line 511 in FIG. 7.

At the end of fifth phase 510, the controller 108 is configured to move to a sixth phase 512 in which the controller 108 is configured to maintain the heater tracks 114 at a target temperature of 240 degrees Celsius, represented by line 513 in FIG. 7. The sixth phase start corresponds to the fifth phase end. In the sixth phase 510, the controller 108 is configured to maintain the measured temperature of the heater tracks 114 at the sixth target temperature of 240 degrees.

In the third embodiment, the first, second, third and fourth phases 502, 504, 506 and 508 may be referred to as the pre-heating phase.

FIG. 8 to 12 show a fourth embodiment of a heating routine implemented by the controller 108 whereby the controller 108 is configured to limit the average power supplied by the power supply 106 so as to not to exceed a threshold average power and so that the amount of energy supplied to the heater assembly does not exceed a threshold energy.

Step 802 of FIG. 8 is split into three sub steps: steps 802a to 802c. Throughout step 802, the controller is configured to perform each of steps 802a to 802c every millisecond for a 50 millisecond period.

At step 802a, the controller 108 is configured to measure the instantaneous power supplied to the heater tracks 114. The controller 108 is able to determine the instantaneous power supplied to the heater tracks 114 based on measurements of the voltage and current supplied to the heater tracks 114 by the power supply 106. These measurements are made by a voltmeter and an ammeter not shown in the Figures. Instantaneous power is then determined by multiplying the voltage by the current. The power determined in step 802a is an instantaneous power.

At step 802b, the controller 108 is configured to determine the cumulative energy supplied to the heater tracks 114 since the start of the 50 millisecond period introduced in step 802.

In order to determine the cumulative energy, the controller 108 is first configured to determine the energy supplied to the heater tracks throughout the previous millisecond. This is possible because the amount of energy supplied during a particular time interval is equal to instantaneous power multiplied by the time interval. So, the energy supplied to the heater tracks in the last millisecond is determined by multiplying the instantaneous power determined in step 802a by 0.001 (i.e. millisecond). This calculation assumes that the instantaneous power determined in step 802a is constant during the previous millisecond.

After determining the energy supplied to the heater tracks throughout the previous millisecond, the controller is configured to determine the cumulative energy by maintaining a running total of the amount of energy determined to have been supplied to the heater tracks each millisecond.

At step 802c, the controller is configured to limit the power supplied to the heater tracks 114 if the cumulative energy is equal to or greater than a threshold energy. Limiting power supplied to the heater tracks 114 means stopping the supply of power to the heater tracks. The threshold energy is a value stored in the memory of the controller. In this embodiment, the threshold energy is 540 milliJoules.

Because energy and power are related, limiting the power supplied to the heater tracks when the cumulative energy is equal to or greater than the threshold energy is equivalent to limiting the power to a threshold average power. The threshold average power corresponds to a power which would result in the threshold energy being delivered during the 50 millisecond period. In other words, because the threshold energy is 540 milliJoules and the period is 50 milliseconds, the threshold average power is 540 milliJoules divided by 50 milliseconds which is 10.8 Watts. The effect of stopping or limiting power when the cumulative energy is equal to or greater than the threshold energy until the end of the 50 millisecond period is that the average power supplied throughout the 50 millisecond period is no more than the threshold average power.

Step 804 is to repeat step 802 for n further 50 millisecond periods. In this embodiment, step 802 is repeated for sequential 50 millisecond periods continuously throughout the usage session of the aerosol-generating device 100.

FIG. 9 is a graph 600 showing the cumulative energy supplied to the heater tracks 114 during the 50 millisecond period of step 802. The X axis represents time in seconds. The Y axis represents cumulative energy supplied to the heater tracks 114. FIG. 9 shows that, for about the first 24 milliseconds, the cumulative energy increases linearly. This demonstrates that for about the first 24 milliseconds that the instantaneous power supplied to heater tracks 114, as determined each millisecond as per step 802a, was constant. However, by the 25^{th} millisecond the cumulative energy has reached the threshold energy stored in the controller 108 and represented by the dotted line 602 in FIG. 9. Therefore, for the rest of the 50 millisecond period, power is no longer supplied to the heater tracks. This means that the cumulative energy supplied to the heater tracks 114 stops increasing after about the 25^{th} millisecond and so does not exceed the threshold energy.

FIG. 10 is another graph 700 showing the power supplied to heater tracks 114, rather than energy as in FIG. 9. FIG. 10 shows two sequential 50 millisecond periods. The X axis of FIG. 10 represents time in seconds. The Y axis represents power supplied to the heater tracks 114. It was described in relation to FIG. 9 that the power supplied to the heater tracks 114 during the 50 millisecond period is constant until about 24 milliseconds, after which power is stopped from being supplied for the rest of the 50 millisecond period. This is also shown in FIG. 10 which shows the power as a constant non-zero value initially and then zero after about 24 milliseconds. The same pattern repeats for the second 50 millisecond period.

By limiting power when the cumulative energy is equal to the threshold energy, the average power that is delivered during any 50 millisecond period is equal to a threshold average power, as described above. The average power is represented by line 702 in FIG. 10. The threshold average power is chosen as a power that is high enough to provide fast heating while being limited enough account for variability in the maximum amount of power being supplied by the power supply 106 at any given time. For example, the maximum power that can be supplied by the power supply 106 at any given time will depend on the charge state of the battery. When the battery is fully charged, it is able to deliver a higher maximum power than when it is depleted. This is because the voltage of the battery will fall as the battery gets depleted.

Because the maximum power available falls as the power supply depletes, the user experience during usage sessions at different charge states of the power supply would be inconsistent without the power limitation described above. For example, in later usage sessions, the time taken for the heater tracks 114 to heat up to an operational temperature may be much longer or the amount of aerosol generated during a usage session may be lower. By limiting power to the predetermined power, the average power supplied during any 50 millisecond period can be delivered in most charge states of the power supply 106 which means that the aerosol-generating device is more consistent.

The threshold average power is 10.8 Watts in this embodiment which is chosen as a value which strikes a good balance between being high enough that the heater tracks 114 increase temperature quickly while being a value which is obtainable from the power source 106 in various states of charge.

The change in power limitation control to account for different charges states of the power supply 106 is shown more clearly by comparing FIG. 10 to FIG. 11. Unlike in FIG. 10 where the power supply 106 is fully charged, the power supply 106 in FIG. 11 is somewhat depleted. So, in FIG. 11, the maximum power that can be supplied by the power supply 106 is less than in FIG. 10. Hence the instantaneous power supplied initially in each of the 50 millisecond periods of FIG. 11 is lower than in FIG. 10. This means it takes longer in FIG. 11 for the cumulative energy to reach the maximum energy because lower power means less energy being supplied during each 1 millisecond period. Thus, in FIG. 11, power is supplied to the heater tracks 114 for longer than in FIG. 10 (about 40 milliseconds rather than about 25 milliseconds). However, in both FIGS. 10 and 11, 540 milliJoules of energy is supplied to the heater tracks during each 50 millisecond period corresponding to an average power of 10.8 Watts over the 50 millisecond period.

In FIGS. 10 and 11, the amount the power of the power supply drops as it is depleted is exaggerated. If the energy delivered in each of the 50 millisecond time intervals of FIGS. 10 and 11 is 540 milliJoules, then the maximum power in FIG. 10 is about 21.6 Watts dropping to about 13.4 Watts in FIG. 11. In reality, the power drop is more likely to be of the order of a couple of Watts.

The heating routine of the fourth embodiment, in which energy and power is limited, can be applied to the first, second and third embodiments described above and can be applied for all or a portion of a usage session of those embodiments. For example, in the first phase 202 of FIG. 4, the heating of the heater tracks towards a first target temperature of 250 degrees involves supplying power to the heater tracks 114 until the measured temperature of the heater tracks 114 reaches the first target temperature. The power supplied in this phase is the average power of 10.8 Watts.

Of course, during some 50 millisecond periods, the average power may be less than 10.8 Watts. This may be, for example, during periods where no power is supplied to the heater tracks because the heater tracks 114 are already hotter than a target temperature or because a lower power is being supplied to ensure that the heater tracks 114 have a constant rate of change of temperature. In those cases, the routine of FIG. 8 is still applied, but step 802c is not reached.

FIG. 12 shows a graph 900 representing a heating profile applied by an aerosol-generating device 100 according to the embodiment of FIG. 1, to an aerosol-forming substrate 202 of an aerosol-generating article 200 during a usage session. The y-axis of the graph represents temperature and the x-axis of the graph represents time in seconds. This heating profile may result in superior generation of aerosol when used with an external heating device such as that disclosed in the embodiment of FIG. 1. The usage session lasts for 265 seconds between a start of the usage session and the end of the usage session. The heating profile comprises six sequential phases.

The duration of each phase may be controlled based on a combination of signals, such as temperature and time signals. For example, the duration of each of the sequential phases may be controlled as described above in relation to embodiments of FIGS. 4 to 7.

A first phase 902 lasts from the start of the usage session (t=0 seconds). The first phase 902 is dynamic in length. If, at any time during the first phase 902 the controller 108 determines that the temperature of the heater tracks 114, as measured by the temperature sensor 104, exceeds a first target temperature of 210 degrees Celsius then the controller 108 is configured to progress to the second phase 904. The first target temperature is represented by line 903 in FIG. 12. However, the first phase 902 has a maximum length of ten seconds and so the first phase end is, at the latest, ten seconds after the first phase start. If the ten seconds of the first phase 402 elapse before the controller 108 determines that the temperature of the heater tracks 114 exceeds the first target temperature 903, the controller 108 will progress to the second phase 904 regardless. In FIG. 12, the controller 108 has determined that the heater tracks 114 reached the first target temperature 903 slightly before the maximum length of the first phase 902. Therefore, the first phase end is about eight seconds after the first phase start, rather than the maximum ten seconds.

Throughout the second phase 904 the controller is configured to heat the heater tracks 114 toward a second target temperature of 255 degrees Celsius, represented by line 905 in FIG. 12. Once the controller 108 has determined that the measured temperature of the heater tracks 114 has reached the second target temperature 905, the controller 108 is configured to move to the third phase 906. In other words, the second phase end is when the controller 108 has determined that the measured temperature of the heater tracks 114 has reached the second target temperature 905. In the graph of FIG. 12 this occurs 20 seconds after the start of the usage session.

The third phase 906 is of fixed duration. The third phase end is 10 seconds after the third phase start and the third phase start corresponds to the second phase end. In the third phase 906, the controller is configured to maintain the measured temperature of the heater tracks 114 at a third target temperature, also of 255 degrees as represented by line 907 in FIG. 12.

The first, second and third phases 902, 904 and 906 may be referred to as the early heating phase, or first period, of the usage session.

At the end of third phase 906, the controller 108 is configured to move to a fourth phase 908 in which the controller is configured to allow the heater tracks 114 to reach a fourth target temperature of 195 degrees Celsius, as represented by line 909 in FIG. 12. The fourth phase start corresponds to the third phase end. The fourth phase ends when the controller 108 has determined that the measured temperature of the heater tracks 114 has reached the fourth target temperature 909. In the graph of FIG. 12 this occurs 75 seconds after the start of the usage session.

The fifth phase 910 is of fixed duration. The fifth phase end is 30 seconds after fifth phase start. In the fifth phase 910, the controller is configured to maintain the measured temperature of the heater tracks 114 at the fifth target temperature of 195 degrees, represented by line 911 in FIG. 12.

The fourth and fifth phases may be referred to as a second period of the usage session.

At the end of fifth phase 910, the controller 108 is configured to move to a sixth phase 912 in which the controller 108 is configured to maintain the heater tracks 114 at a sixth target temperature of 218 degrees Celsius, represented by line 913 in FIG. 12. The sixth phase start corresponds to the fifth phase end. The sixth phase ends 165 seconds after the start of the usage session.

At the end of sixth phase 912, the controller 108 is configured to move to a seventh phase 914 in which the controller 108 is configured to maintain the heater tracks 114 at a seventh target temperature of 225 degrees Celsius, represented by line 915 in FIG. 12. The seventh phase start corresponds to the sixth phase end. The seventh phase ends 200 seconds after the start of the usage session.

At the end of seventh phase 914, the controller 108 is configured to move to an eighth phase 916 in which the controller 108 is configured to maintain the heater tracks 114 at an eighth target temperature of 250 degrees Celsius, represented by line 917 in FIG. 12. The eighth phase start corresponds to the seventh phase end. The eighth phase ends when the eighth target temperature has been reached. In FIG. 12, the eighth phase ends 250 seconds after the start of the usage session.

At the end of eighth phase 916, the controller 108 is configured to move to a ninth phase 918 in which the controller 108 is configured to maintain the heater tracks 114 at a ninth target temperature of 250 degrees Celsius, represented by line 919 in FIG. 12. The ninth phase start corresponds to the eighth phase end. The ninth phase ends 265 seconds after the start of the usage session.

The sixth, seventh, eighth, and ninth phases may be referred to as a third period of the usage session.

At the end of the ninth phase the usage session ends and the heater is switched off.

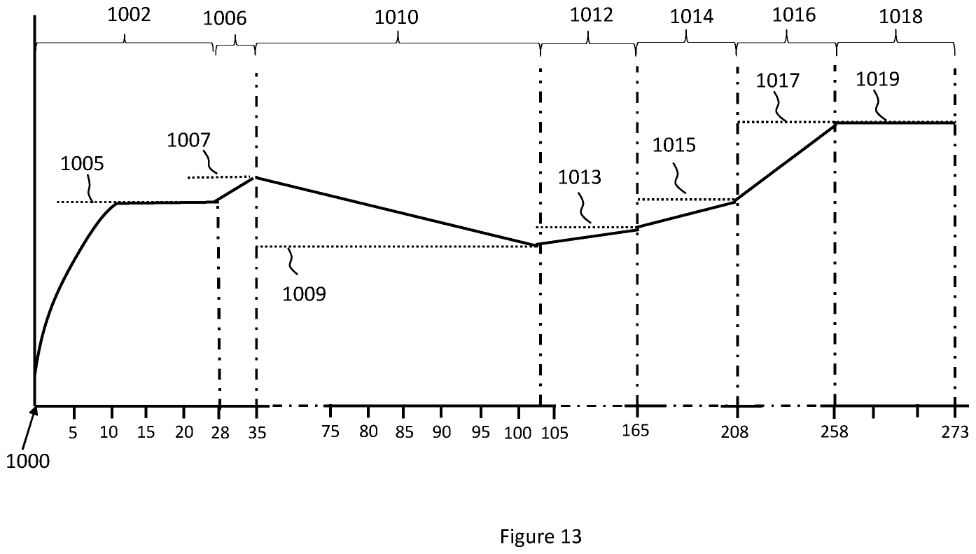

FIG. 13 shows a graph 1000 representing a further specific example of a heating profile applied by an aerosol-generating device 100 according to the embodiment of FIG. 1, to an aerosol-forming substrate 202 of an aerosol-generating article 200 during a usage session. As with FIG. 12, the y-axis of the graph represents temperature and the x-axis of the graph represents time in seconds. This heating profile may result in superior generation of aerosol when used with an external heating device such as that disclosed in the embodiment of FIG. 1. The usage session lasts for 273 seconds between a start of the usage session and the end of the usage session. The heating profile comprises seven sequential phases of fixed length.

A first phase 1002 lasts from the start of the usage session (t=0 seconds). The first target temperature is represented by line 1005 in FIG. 13. The first target temperature is 235 degrees Celsius and the first phase has a length of 28 seconds. During the first phase, power is supplied at 6.5 Watts until the target temperature is achieved, and thereafter power is supplied to maintain the temperature at the first target temperature until the end of the first phase.

A second phase 1006 lasts from the end of the first phase (28 seconds from start of the usage session) until 35 seconds from the start of the usage session. During the second phase, the temperature increases linearly from 235 degrees Celsius to a second target temperature 1007 of 240 degrees Celsius. The first and second phase may be described as an initial period in which temperature is increased from an initial temperature (that is ambient temperature) to a first temperature (240 degrees Celsius).

A third phase 1010 is of fixed duration. The third phase lasts from the second phase end (35 seconds from start of the usage session) to 103 seconds from start of the usage session. During the third phase the temperature is controlled to decline linearly from 240 degrees Celsius to a third target temperature 1009 of 200 degrees Celsius. The third phase may be described as a second phase in which temperature of the heating element drops to a second temperature (200 degrees Celsius) below the first temperature.

At the end of third phase 1010, the controller 108 is configured to move to a fourth phase 1012 in which the controller is configured to allow the heater tracks 114 to reach a fourth target temperature 1013 of 218 degrees Celsius. The fourth phase lasts from the third phase end (103 seconds from start of the usage session) to 165 seconds from start of the usage session.

At the end of fourth phase 1012, the controller 108 is configured to move to a fifth phase 1014 in which the controller is configured to allow the heater tracks 114 to reach a fifth target temperature 1015 of 225 degrees Celsius. The fifth phase lasts from the fourth phase end (165 seconds from start of the usage session) to 208 seconds from start of the usage session.

At the end of fifth phase 1014, the controller 108 is configured to move to a sixth phase 1016 in which the controller is configured to allow the heater tracks 114 to reach a sixth target temperature 1017 of 250 degrees Celsius. The sixth phase lasts from the fourth phase end (208 seconds from start of the usage session) to 258 seconds from start of the usage session. The fourth, fifth, and sixth phases may be described as a third period during which temperature of the heating element is increased to a third temperature (250 degrees Celsius) higher than the second temperature.

At the end of sixth phase 1016, the controller 108 is configured to move to a seventh phase 1018 in which the controller is configured to maintain the heater tracks 114 at a target temperature 1019 of 250 degrees Celsius. The sixth phase lasts from the fifth phase end (258 seconds from start of the usage session) to 273 seconds from start of the usage session, at which point the heater is switched off and the usage session ends.

Power supplied during the first period (i.e. first and second phases) may be 6.5 W, whereas power supplied during the second and third periods (i.e. third, fourth, fifth, sixth, and seventh phases) may be reduced to 5.5 W.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A ±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-49. (canceled)

50. A method of controlling aerosol production in an aerosol-generating device,
the aerosol-generating device comprising:
a heating chamber configured to at least partially receive an aerosol-generating article comprising an aerosol-forming substrate,
a heater comprising at least one heating element configured to externally heat the aerosol-forming substrate, and
a power source configured to provide power to the at least one heating element; and
the method comprising the steps of:
controlling the power provided to the at least one heating element such that in an initial period power is provided such that a temperature of the at least one heating element increases from an initial temperature to a first temperature, in a second period power is provided such that the temperature of the at least one heating element drops to a second temperature below the first temperature, and in a third period power is provided such that the temperature of the at least one heating element increases to a third temperature higher than the second temperature, wherein the first temperature is a temperature of between 230° C. and 270° C., and wherein the aerosol-generating device is configured to generate the aerosol during a usage session,
dividing at least a portion of the usage session into n sequential time intervals, and
limiting the power supplied to the at least one heating element during any or each of the n sequential time intervals such that a threshold energy for that time interval is not exceeded.

51. The method of controlling aerosol production according to claim 50, wherein the first temperature is a temperature of between 235° C. and 245° C. or between 245° C. and 265° C.

52. The method of controlling aerosol production according to claim 50, wherein the second temperature is a temperature of between 140° C. and 220° C.

53. The method of controlling aerosol production according to claim 50, wherein the third temperature is a temperature of between 230° C. and 270° C.

54. The method of controlling aerosol production according to claim 50, wherein the first period has a duration of between 20 seconds and 40 seconds.

55. The method of controlling aerosol production according to claim 50, wherein the second period has a duration of between 40 seconds and 100 seconds.

56. The method of controlling aerosol production according to claim 50, wherein the third period has a duration of between 40 seconds and 100 seconds.

57. The method of controlling aerosol production according to claim 50, wherein the usage session has a usage session start and a usage session end.

58. The method of controlling aerosol production according to claim 57, wherein the temperature of the at least one heating element is at the initial temperature at the usage session start and in which an end of the third period is the usage session end.

59. The method of controlling aerosol production according to claim 58, wherein the step of controlling the power provided to the at least one heating element is performed so as to maintain the temperature of the at least one heating element within a desired temperature range in the second period and in the third period of the usage session.

60. The method of controlling aerosol production according to claim 59, wherein the desired temperature range has a lower bound of between 140° C. and 220° C. and an upper bound of between 230° C. and 270° C.

61. The method of controlling aerosol production according to claim 50, wherein the first period is ended when the at least one heating element reaches the first temperature.

62. The method of controlling aerosol production according to claim 50, wherein a duration of the second period is determined based on a total amount of power provided to at least one heating element during the second period.

63. The method of controlling aerosol production according to claim 50,
further comprising detecting user puffs on the aerosol-generating device,
wherein the first, the second, or the third period is ended following detection of a predetermined number of user puffs.

64. An electrically operated aerosol-generating device configured to generate an aerosol during a usage session, the electrically operated aerosol-generating device comprising:
a heating chamber configured to at least partially receive an aerosol-generating article comprising an aerosol-forming substrate;
a heater comprising at least one heating element configured to externally heat the aerosol-forming substrate;
a power source configured to provide power to the at least one heating element; and
electric circuitry configured to
control a supply of power from the power supply to the at least one heating element,
control the power provided to the at least one heating element such that in an initial period power is provided such that a temperature of the at least one heating element increases from an initial temperature to a first temperature, in a second period power is provided such that the temperature of the at least one heating element drops to a second temperature below the first temperature, and in a third period power is provided such that the temperature of the at least one heating element increases to a third temperature higher than the second temperature, wherein the first temperature is a temperature of between 230° C. and 270° C.,
divide at least a portion of the usage session into n sequential time intervals, and
limit the power supplied to the at least one heating element during any or each of the n sequential time intervals such that a threshold energy for that time interval is not exceeded.

65. The electrically operated aerosol-generating device according to claim 64,
wherein the electric circuitry is further configured such that at least one of the first period, the second period, and the third period has a fixed duration.

66. The electrically operated aerosol-generating device according to claim 64,
further comprising means for detecting user puffs on the electrically operated aerosol-generating device,
wherein the electric circuitry is further configured such that at least one of the first, the second, or the third period is ended following detection of a predetermined number of user puffs.

67. The electrically operated aerosol-generating device according to claim 64, wherein the electrically operated aerosol-generating device is configured to perform a method comprising the steps of:
controlling the power provided to the at least one heating element such that in the initial period power is provided such that the temperature of the at least one heating element increases from the initial temperature to the first temperature, in the second period power is provided such that the temperature of the at least one heating element drops to the second temperature below the first temperature, and in the third period power is provided such that the temperature of the at least one heating element increases to the third temperature higher than the second temperature, wherein the first temperature is the temperature of between 230° C. and 270° C., and wherein the aerosol-generating device is further configured to generate the aerosol during a usage session,
dividing at least the portion of the usage session into the n sequential time intervals, and
limiting the power supplied to the at least one heating element during any or each of the n sequential time intervals such that the threshold energy for that time interval is not exceeded.

68. An aerosol-generating system comprising the electrically operated aerosol-generating device according to claim 64 and an aerosol-generating article configured to be received in the heating chamber of the electrically operated aerosol-generating device.

69. The aerosol-generating system according to claim 68, wherein the aerosol-generating article comprises an aerosol-forming substrate.
